(19) United States
(12) Patent Application Publication
(10) Pub. No.: US 2026/0027576 A1
(43) Pub. Date: Jan. 29, 2026

(54) MULTI COMPONENT FLOOR SURFACE DISPENSING RIG

(71) Applicant: Graco Minnesota Inc., Minneapolis, MN (US)

(72) Inventors: Derek R. Shaw, Hopkins, MN (US); Jeromy D. Horning, Albertville, MN (US); Dale C. Pemberton, Big Lake, MN (US); Jacob T. R. Renollett, Elk River, MN (US); Kenneth C. Floer, Brooklyn Park, MN (US); James C. Schroeder, Ramsey, MN (US)

(21) Appl. No.: 18/997,985

(22) PCT Filed: Aug. 8, 2023
(86) PCT No.: PCT/US2023/029750

§ 371 Date: Jan. 23, 2025

Related U.S. Application Data
(60) Provisional application No. 63/396,490, filed on Aug. 9, 2022.
(60) Provisional application No. 63/529,011, filed on Jul. 26, 2023.

(51) Int. Cl. B05B 12/14; B05B 13/00; F04B 17/03; F04B 23/06

(52) U.S. Cl. CPC B05B 12/1445; B05B 13/005; F04B 17/03; F04B 23/06

(57) ABSTRACT

A floor surface dispense rig is configured to mix multiple constituent materials together to form a plural component flooring material and is configured to output that plural component material onto a ground surface. The dispense rig includes multiple displacers that draw the individual constituent materials from material supplies and pump the constituent materials to a dispenser for emitting the resultant plural component material.

### CROSS-REFERENCE TO RELATED APPLICATION(S)

This application claims the benefit of U.S. Provisional Application No. 63/396,490 filed Aug. 9, 2022 and entitled “MULTI COMPONENT FLOOR SURFACE DISPENSING RIG,” and claims the benefit of U.S. Provisional Application No. 63/529,011 filed Jul. 26, 2023 and entitled “MULTI COMPONENT FLOOR SURFACE DISPENSING RIG,” the disclosures of which are hereby incorporated by reference in their entireties.

### BACKGROUND

This disclosure relates to material dispensing systems. More particularly, this disclosure relates to a rig for mixing and dispensing flooring material. Flooring material can be applied to a floor surface to provide a coating on that floor surface to improve durability, aesthetics, grip, etc. For example, the flooring material can be an epoxy coating. The flooring materials are typically formed from multiple constituent components that are mixed together to form a plural component flooring material. The multiple constituent components are typically poured individually into a mixing container, such as a bucket. The operator then mixes the components together to generate the plural component flooring material, such as with a hand mixer, such as an auger connected to a handheld drill. The plural component flooring material is poured onto the floor surface to be coated and spread over that surface, such as with a squeegee.

### SUMMARY

According to an aspect of the disclosure, a mobile floor surface dispense rig for applying a coating material to a flooring surface includes an applicator frame; a plurality of wheels connected to the applicator frame and configured to support the applicator frame on the flooring surface; at least one support connected to the applicator frame, the at least one support configured to support a first material supply holding a supply of a first material and a second material supply holding a supply of a second material; a first displacer supported by the applicator frame and configured to draw the first material from the first material supply and pump the first material to a dispenser; and a second displacer supported by the applicator frame and configured to draw the second material from the second material supply and pump the second material to the dispenser. The first displacer and the second displacer are movable relative to the applicator frame and between respective immersed states, in which the first displacer extends into the first material supply through a top opening of the first material supply and the second displacer extends into the second material supply through a top opening of the second material supply, and respective stowed states, in which the first displacer is removed from the first material supply and at least partially disposed over the top opening of the first material supply and the second displacer is removed from the second material supply and at least partially disposed over the top opening of the second material supply.

According to an additional or alternative aspect of the disclosure, a mobile floor surface dispense rig for applying a coating material to a flooring surface includes an applicator frame; a plurality of wheels connected to the applicator frame and configured to support the applicator frame on the flooring surface; at least one support connected to the applicator frame, the at least one support configured to support a first material supply holding a supply of a first material and a second material supply holding a supply of a second material; a first displacer supported by the applicator frame, the first displacer including a first pump configured to draw the first material from the first material supply and pump the first material to a dispenser; a second displacer supported by the applicator frame, the second displacer including a second pump configured to draw the second material from the second material supply and pump the second material to the dispenser; a first supply line extending from the first pump to a dispense manifold, the first supply line configured to receive the first material output by the first displacer; and a second supply line extending from the second pump to the dispense manifold, the second supply line configured to receive the second material output by the second displacer. The first pump, the second pump, the first supply line, the second supply line, and the dispense manifold are connected together as a fluid handling assembly configured to move together as a single unit between a first state in which the first pump and the second pump are in respective immersed states in which the first pump extends into the first material supply through a top opening of the first material supply and the second pump extends into the second material supply through a top opening of the second material supply, and a second state in which the first pump and the second pump are in respective stowed states in which the first pump is removed from the first material supply and at least partially disposed over the top opening of the first material supply and the second pump is removed from the second material supply and at least partially disposed over the top opening of the second material supply.

According to another additional or alternative aspect of the disclosure, a mobile floor surface dispense rig for applying a coating material to a flooring surface includes an applicator frame; a plurality of wheels connected to the applicator frame and configured to support the applicator frame on the flooring surface; at least one support connected to the applicator frame, the at least one support configured to support a first material supply holding a supply of a first material and a second material supply holding a supply of a second material; a first displacer supported by the applicator frame, and a second displacer supported by the applicator frame. The first displacer includes a first drive assembly; and a first pump connected to the first drive assembly to be driven by the first drive assembly to draw the first material from the first material supply and pump the first material to a dispenser. The first pump is removably mounted to the first drive assembly. The second displacer includes a second drive assembly; and a second pump connected to the second drive assembly to be driven by the second drive assembly to draw the second material from the second material supply and pump the second material to a dispenser. The second pump is removably mounted to the second drive assembly. The first pump is fixed to the second pump such that the first pump and the second pump are removable together from the first drive assembly and the second drive assembly and are mountable together from the first drive assembly and the second drive assembly.

According to yet another additional or alternative aspect of the disclosure, a mobile floor surface dispense rig for applying a coating material to a flooring surface includes an applicator frame; a plurality of wheels connected to the applicator frame and configured to support the applicator frame on the flooring surface; at least one support connected to the applicator frame, the at least one support configured to support a first material supply holding a supply of a first material and a second material supply holding a supply of a second material; a first displacer supported by the applicator frame, and a second displacer supported by the applicator frame. The first displacer includes a first drive assembly; and a first pump connected to the first drive assembly to be driven by the first drive assembly to draw the first material from the first material supply and pump the first material to a dispenser. The first displacer is movable relative to the applicator frame between a first immersed state in which a first inlet of the first pump is disposed vertically below a top opening of the first material supply and a first stowed state in which the first inlet of the first pump is disposed vertically above the top opening of the first material supply. The second displacer includes a second drive assembly; and a second pump connected to the second drive assembly to be driven by the second drive assembly to draw the second material from the second material supply and pump the second material to a dispenser. The second displacer is movable relative to the applicator frame between a second immersed state in which a second inlet of the second pump is disposed vertically below a top opening of the second material supply and a second stowed state in which the second inlet of the second pump is disposed vertically above the top opening of the second material supply.

According to yet another additional or alternative aspect of the disclosure, a mobile floor surface dispense rig for applying a coating material to a flooring surface includes an applicator frame; a plurality of wheels connected to the applicator frame and configured to support the applicator frame on the flooring surface; at least one support connected to the applicator frame, the at least one support configured to support a first material supply holding a supply of a first material and a second material supply holding a supply of a second material; a first displacer supported by the applicator frame, the first displacer configured to displace the first material from the first material supply to a dispenser; and a second displacer supported by the applicator frame, the second displacer configured to displace the second material from the second material supply to the dispenser. The first displacer includes a first drive assembly including a first electric motor; and a first pump connected to the first drive and configured to be powered to pump by the first drive. The second displacer includes a second drive assembly including a second electric motor; and a second pump connected to the second drive and configured to be powered to pump by the second drive. The first displacer is movable between a first immersed state, in which the first pump extends into the first material supply, and a first stowed state, in which the first pump is removed from the first material supply and at least partially disposed over a top opening of the first material supply. The second displacer is movable between a second immersed state, in which the second pump extends into the second material supply, and a second stowed state, in which the second pump is removed from the second material supply and at least partially disposed over a top opening of the second material supply.

According to yet another additional or alternative aspect of the disclosure, a mobile floor surface dispense rig for applying a coating material to a flooring surface includes an applicator frame; a plurality of wheels connected to the applicator frame and configured to support the applicator frame on the flooring surface; at least one support connected to the applicator frame, the at least one support configured to support a first material supply holding a supply of a first material and a second material supply holding a supply of a second material; a first displacer supported by the applicator frame and configured to draw the first material from the first material supply and pump the first material to a dispenser; a second displacer supported by the applicator frame and configured to draw the second material from the second material supply and pump the second material to the dispenser; and a power source supported by the applicator frame and configured to provide electrical power to the first displacer and the second displacer to power pumping by the first displacer and the second displacer.

According to yet another additional or alternative aspect of the disclosure, a mobile floor surface dispense rig for applying a coating material to a flooring surface includes an applicator frame; a plurality of wheels connected to the applicator frame and configured to support the applicator frame on the flooring surface; at least one support connected to the applicator frame, the at least one support configured to support a first material supply holding a supply of a first material and a second material supply holding a supply of a second material; a first displacer supported by the applicator frame and configured to draw the first material from the first material supply and pump the first material to a dispenser; a second displacer supported by the applicator frame and configured to draw the second material from the second material supply and pump the second material to the dispenser; and a power source supported by the applicator frame and configured to provide electrical power to the first displacer and the second displacer to power pumping by the first displacer and the second displacer, the power source including a battery and an inverter, wherein the battery is disposed directly vertically above the inverter.

According to yet another additional or alternative aspect of the disclosure, a mobile floor surface dispense rig for applying a coating material to a flooring surface includes an applicator frame; a plurality of wheels connected to the applicator frame and configured to support the applicator frame on the flooring surface; a first support disposed on a first lateral side of a longitudinal centerline of the dispense rig, the first support configured to support a first material supply holding a supply of a first material; a second support disposed on a second lateral side of the longitudinal centerline, the second support configured to support a second material supply holding a supply of a second material; a first displacer supported by the applicator frame and configured to draw the first material from the first material supply and pump the first material to a dispenser; a second displacer supported by the applicator frame and configured to draw the second material from the second material supply and pump the second material to the dispenser; and a power source supported by the applicator frame and configured to provide electrical power to the first displacer and the second displacer to power pumping by the first displacer and the second displacer. The power source is disposed longitudinally rearward of the first support and the second support.

According to yet another additional or alternative aspect of the disclosure, a mobile floor surface dispense rig for applying a coating material to a flooring surface includes an applicator frame; a plurality of wheels connected to the applicator frame and configured to support the applicator frame on the flooring surface; at least one support connected to the applicator frame, the at least one support configured to support a first material supply holding a supply of a first material and a second material supply holding a supply of a second material; a first displacer supported by the applicator frame and configured to draw the first material from the first material supply and pump the first material to a dispenser; a second displacer supported by the applicator frame and configured to draw the second material from the second material supply and pump the second material to the dispenser; and a battery supported by the applicator frame and configured to provide electrical power to the first displacer and the second displacer to power pumping by the first displacer and the second displacer. The battery is disposed laterally between the first displacer and the second displacer.

According to yet another additional or alternative aspect of the disclosure, a mobile floor surface dispense rig for applying a coating material to a flooring surface includes an applicator frame; a plurality of wheels connected to the applicator frame and configured to support the applicator frame on the flooring surface; a first support disposed on a first lateral side of a longitudinal centerline of the dispense rig, the first support configured to support a first material supply holding a supply of a first material; a second support disposed on a second lateral side of the longitudinal centerline, the second support configured to support a second material supply holding a supply of a second material; a first displacer supported by the applicator frame and configured to draw the first material from the first material supply and pump the first material to a dispenser; and a second displacer supported by the applicator frame and configured to draw the second material from the second material supply and pump the second material to the dispenser. The first support is disposed at a first longitudinally forward-most lateral corner of the applicator frame and the second support is disposed at a second longitudinally forward-most lateral corner of the applicator frame.

According to yet another additional or alternative aspect of the disclosure, a mobile floor surface dispense rig for applying a coating material to a flooring surface includes an applicator frame; a plurality of wheels connected to the applicator frame and configured to support the applicator frame on the flooring surface; at least one support connected to the applicator frame, the at least one support configured to support a first material supply holding a supply of a first material; and a first pump supported by the applicator frame, the first pump configured to displace the first material from the first material supply to a dispenser, wherein the first pump is formed as an immersion pump such that at least one valve of the pump is disposed within the first material supply.

According to yet another additional or alternative aspect of the disclosure, a mobile floor surface dispense rig for applying a coating material to a flooring surface includes an applicator frame; a plurality of wheels connected to the applicator frame and configured to support the applicator frame on the flooring surface; at least one support connected to the applicator frame, the at least one support configured to support a first material supply holding a supply of a first material; and a first pump supported by the applicator frame, the first pump configured to displace the first material from the first material supply to a dispenser, wherein the first pump is formed as an immersion pump such that a piston seal of a piston of the first pump is disposed within the first material supply.

According to yet another additional or alternative aspect of the disclosure, a mobile floor surface dispense rig for applying a coating material to a flooring surface includes an applicator frame; a plurality of wheels connected to the applicator frame and configured to support the applicator frame on the flooring surface; at least one support connected to the applicator frame, the at least one support configured to support a first material supply holding a supply of a first material and a second material supply holding a supply of a second material; a first displacer supported by the applicator frame and configured to draw the first material from the first material supply and pump the first material to a dispenser;

a second displacer supported by the applicator frame and configured to draw the second material from the second material supply and pump the second material to the dispenser; and a dispense support projecting outward relative to the applicator frame, the applicator arm supporting the dispenser and repositionable relative to the applicator frame.

According to yet another additional or alternative aspect of the disclosure, a mobile floor surface dispense rig for applying a coating material to a flooring surface includes an applicator frame; a plurality of wheels connected to the applicator frame and configured to support the applicator frame on the flooring surface; at least one support connected to the applicator frame, the at least one support configured to support a first material supply holding a supply of a first material and a second material supply holding a supply of a second material; a first displacer supported by the applicator frame and configured to draw the first material from the first material supply and pump the first material to a dispenser; a second displacer supported by the applicator frame and configured to draw the second material from the second material supply and pump the second material to the dispenser; and a dispense support projecting outward relative to the applicator frame, the dispense support supporting the dispenser, wherein the dispense support is configured to move laterally relative to the applicator frame, move vertically relative to the applicator frame, and move rotationally on an arm axis of the dispense support.

According to yet another additional or alternative aspect of the disclosure, a mobile floor surface dispense rig for mixing multiple fluid components and then dispensing includes a plurality of wheels; a frame that rides on the plurality of wheels; one or more supports for holding a first material supply and a second material supply; a first pump which receives a first constituent material from the first material supply and outputs the first constituent material; a second pump which receives a second constituent material from the second material supply and outputs the second constituent material; one or more motors that operate the first pump and the second pump; and a dispenser, the dispenser receiving the first constituent material output by the first pump and the second constituent material output by the second pump, the dispenser configured to mix the first constituent material with the second constituent material and dispense a mixture of the first and second constituent materials on a floor surface.

### BRIEF DESCRIPTION OF THE DRAWINGS

FIG. 1A is a first isometric view of a flooring material dispense rig.

FIG. 1B is a second isometric view of the flooring material dispense rig.

FIG. 2 is a cross-sectional view of a displacer.

FIG. 3A is an isometric view of the flooring material dispense rig with the displacement assembly in a stowed position.

FIG. 3B is a side elevation view of the flooring material dispense rig with the displacement assembly in the stowed position.

FIG. 4A is an isometric view of the flooring material dispense rig showing pumps dismounted.

FIG. 4B is a side elevation view of the flooring material dispense rig showing the pumps dismounted.

FIG. 5A is an isometric view of the flooring material dispense rig with the shroud removed.

FIG. 5B is a top plan view of the flooring material dispense rig with the shroud removed.

FIG. 5C is a side elevation view of the flooring material dispense rig with the shroud removed.

FIG. 5D is a bottom plan view of the flooring material dispense rig with the shroud removed.

FIG. 5E is a cross-sectional view of the flooring material dispense rig taken along line E-E in FIG. 5B.

FIG. 6A is an isometric view showing a dispense arm for a floor material dispense rig in a left side dispense configuration.

FIG. 6B is a front elevation view of the floor material dispense rig showing the dispenser in a right side dispense configuration.

FIG. 6C is a front elevation view of the floor material dispense rig showing the dispenser in the left side dispense configuration.

FIG. 7 is a front elevation view of the floor material dispense rig showing the dispenser dismounted from an applicator arm.

FIG. 8 is an isometric view of the floor material dispense rig showing the dispenser in a displaced state.

FIG. 9A is a block diagram showing a displacer in an immersed state.

FIG. 9B is a block diagram showing the displacer in an elevated stowed state.

FIG. 10A is a first isometric view of another floor material dispense rig.

FIG. 10B is a second isometric view of the floor material dispense rig shown in FIG. 10A.

### DETAILED DESCRIPTION

According to aspects of the disclosure, a flooring material dispense rig, which can also be referred to as a dispense rig, is configured to mix constituent materials together at a desired ratio to generate a plural component flooring material. The dispense rig is configured to output the plural component material onto a ground surface, such as a concrete slab. The plural component material is spread on the ground surface to coat the ground surface. For example, the dispense rig can be configured to dispense an epoxy coating material onto the ground surface.

The dispense rig includes a frame that is supported by wheels. The wheels are configured to roll along the ground surface to maneuver the dispense rig about the ground surface. Some examples of the dispense rig include a pair of rear wheels. The rear wheels can be fixed such that the rear wheels rotate to roll along the ground surface but do not pivot on vertical axes. Some examples of the dispense rig include one or more front wheels. The one or more front wheels can be formed as caster wheels that are configured to roll along the ground surface and pivot to be oriented in different directions. The dispense rig includes a handle by which a user can push or pull the dispense rig to maneuver the dispense rig.

The dispense rig is configured to support supplies of the individual constituent materials, pump the constituent materials to a mixer in which the constituent materials are combined to form the plural component material, and output the plural component material onto the ground surface.

Some examples of the dispense rig include electrically operated displacers that are electrically powered to pump the constituent materials from the material supplies to the dispenser. For example, a displacer can include a pump and an electric motor that powers pumping by the pump. The displacer can include a drive that converts a rotational output from the electric motor into a linear input to the pump to power pumping by the pump. For example, the drive can convert a rotational output from the electric motor to linear motion for driving reciprocation of a piston of the pump.

The dispense rig includes an onboard supply of electrical energy to power the electric motors. For example, the dispense rig includes one or more batteries that are configured to provide electrical energy to the electric motors. Some examples include an inverter.

The dispense rig can be configured to support the material supplies at locations that are on an opposite longitudinal side of the battery from the handle that the user uses to maneuver the dispense rig. The material supplies disposed longitudinally forward of the battery. The dispense rig can be configured such that the material supplies are disposed on opposite lateral sides of a longitudinal centerline of the dispense rig. The material supplies can be disposed proximate the front longitudinal end of the frame.

The material supply supports can be extend laterally outward relative to other portions of the frame of the dispense rig. The material supply supports can be configured to retain reservoirs of the constituent materials on the dispense rig. For example, the reservoirs can be formed as buckets, such as five gallon buckets, into which the constituent material can be poured through a top opening of the reservoir. In some examples, the dispense rig can be configured such that the reservoirs are retained laterally outward away from the centerline and laterally inward towards the centerline. The dispense rig can be further configured such that the reservoirs are retained longitudinally in a forward longitudinal direction and in a rearward longitudinal direction.

Some examples of the dispense rig include the electrical supply disposed laterally between the material supply supports. For example, a battery can be disposed at least partially laterally between the material supply supports. The battery is disposed laterally between the material reservoirs with the material reservoirs mounted on the dispense rig. The battery can be disposed at least partially laterally between the displacers. The battery can be disposed at least partially laterally between the pumps of the displacers. The battery can be disposed at least partially laterally between the motors of the displacers. The battery can be positioned at least partially vertically above the locations of the openings of the material reservoirs through which the displacers extend into the material reservoirs.

At least a portion of the power supply can be disposed laterally between the rear wheels of the dispense rig. At least a portion of the power supply can be disposed directly laterally between the rear wheels of the dispense rig. The power supply can be disposed directly vertically above a line extending between the rotational axes of the rear wheels. In examples in which the rear wheels are connected by an axle, the power supply can be disposed directly vertically above the axle.

In examples in which the power supply includes an inverter, the inverter can be disposed vertically below the battery. The inverter and battery can be disposed in a common housing. The inverter generates heat, which warms the battery, improving the efficiency of battery operation. In some examples, an opening is formed between the control housing in which a controller of the dispense rig is disposed and the power supply housing in which the power source is disposed such that heat generated by the control components is ported to the power supply housing to warm the battery, improving efficiency of the battery.

The displacers of the displacement assembly can be configured as immersion pumps that extend into the material reservoirs. The pumps can be configured as piston pumps in which a piston reciprocates relative to a pump housing to pump the constituent material. The pump can extend into the material reservoir such that at least one valve of the piston pump is disposed within the reservoir and below the lip that defines the top opening through which the pump extends into the material reservoir. The pump can extend into the material reservoir such that at least one piston seal is disposed within the reservoir and below the lip that defines the top opening. The pump can extend into the material reservoir such that the inlet of the pump is disposed within the material reservoir and below the top opening. The pump inlet can be formed through the pump body such that the pump inlet is rigid.

According to some aspects, one or more of the displacers of the dispense rig can be configured to move between an immersed state in which the pump is at least partially disposed within the material reservoir and a stowed state in which the pump is withdrawn from the reservoirs. The displacer can be configured such that an inlet of the pump is directly vertically above a top opening of the material reservoir with the displacer in the stowed state. According to some aspects, the displacer is configured to pivot between the immersed and stowed states. The displacer can be mounted to the applicator frame at a pivot point. According to some aspects, the displacer is configured to shift vertically between the immersed and stowed states.

According to some aspects, the displacers can be mechanically linked for simultaneous displacement between the immersed and stowed states. In some aspects, a pump of one displacer can be mechanically linked to a pump of another displacer to fix the displacers to each other. Some examples can include displacers that are not mechanically linked to allow for individual displacement between the immersion and stowed states. With a displacer in the stowed state, the displacer is withdrawn from the material reservoir and the material reservoir can be dismounted from the dispense rig.

The stowed state can also be referred to as a no-drip state. With a displacer in the stowed state, a vertically lowest portion of the displacer is disposed vertically over the top opening of the material reservoir through which the displacer extends into the reservoir with the displacer in the immersed state. Positioning the lowest vertical portion of the displacer over the opening of the material reservoir allows any constituent material residue remaining on the exterior of the pump to drip back into the material reservoir, preventing the material from dripping onto the dispense rig or the ground surface.

According to some aspects of the disclosure, the displacer is disposed at an orientation between vertical and horizontal when in the stowed state. The displacer can be oriented such that the pump housing extends vertically downward as the pump housing extends away from the electric motor of the displacer. The displacer can be disposed at an orientation such that a reciprocation axis of the piston is disposed at an orientation between vertical and horizontal with the displacer in the stowed state. The displacer being disposed in such an orientation allows gravity to pull any residual constituent material along the exterior of the pump housing prior to drip into the material reservoir. As such, if a wetted portion of the exterior of the pump housing is disposed outside of the opening of the material reservoir, the constituent material will run along the exterior of the pump housing to vertically lower portions of the pump housing that are disposed over the opening of the material reservoir prior to dripping from the pump housing.

The displacer can be configured to pivot between the immersion and the stowed states. The displacer can pivot such that the reciprocation axis of the piston moves about the pivot point as the displacer moves between the immersed and stowed states. According to some examples, the displacer can be configured to move vertically between the immersed and stowed states, such as by an elevator operation. The displacer can move vertically such that the displacer moves axially relative to the reciprocation axis of the piston between the immersed and stowed states. According to some examples, the displacer can be configured such that the electric motor and the pump move together between the immersion and stowed states.

According to some examples, the fluid displacers are configured such that the pumps are removable from the drive assemblies. For example, the pump potion of a displacer can be disconnected from and removed from the drive portion of the displacer, which drive portion includes components for causing the pump to pump. For example, the drive portion can include an electric motor. The drive portion can remain mounted to the dispense rig when the pumps are mounted and dismounted. In some examples, multiple of the fluid handling portions of the displacers are mechanically linked together such that the multiple fluid handling portions are dismountable together as a single assembly. The multiple fluid handling portions can be mounted to the electric drives simultaneously and can be dismounted from the electric drives simultaneously.

The fluid handling portions of the displacers can be mechanically linked together for mounting and dismounting as the single assembly. The fluid handling portions can be linked together by a bracket or other mechanical connection. Other fluid handling components that receive the constituent materials output from the displacers can form components of the fluid handling portion that are mountable with and dismountable with the pumps of the displacers. Each pump outputs constituent material to a hose that feeds the constituent material to a dispense manifold. The dispense manifold is configured to receive input flows from multiple pumps. The dispense manifold provides outputs to a single mix line that extends between the dispense manifold and a dispenser that outputs the plural component material onto the ground surface. The constituent materials can mix within the dispense manifold and/or can mix within the dispense line that receives outputs from the dispense manifold and/or can mix within the dispenser that outputs the plural component material from the dispense rig.

The dispense manifold and the flow lines, including the multiple lines that extend from the pumps to the dispense manifold and the line that extends from the dispense manifold to the dispenser, can be mounted together such that all fluid handling components are mountable and dismountable together as a single unit. Such a configuration allows for quick and easy replacement of all fluid handling components of the dispense rig, such as to allow for swapping of fluid handling components for pumping and mixing of different constituent materials.

According to some aspects of the disclosure, the dispense rig includes a dispense support, such as one or more arms, that supports and positions the dispenser. The dispenser is mounted to the dispense support and the dispense support positions the dispenser at a desired location for dispensing the plural component material relative to the dispense rig. The dispense support is movable relative to a frame of the dispense rig such that the dispenser can be positioned on either lateral side of the dispense rig. According to some examples, the dispense support is vertically movable relative to the ground surface to position the dispenser vertically closer to the ground surface and vertically further from the ground surface, as desired for application. According to some examples, the dispense support is rotatable to pivot the outlet of the dispenser. The dispenser can be pivoted to reorient the nozzle of the dispenser, such as between vertical and horizontal, to allow for insertion or removal of a bucket from below the dispenser such as during purging of the fluid lines of the dispense rig or dispensing a metered volume into the bucket.

According to some aspects of the disclosure, the dispenser is supported by the dispense support but is removable from a receiving bracket of the dispense support to allow for the dispenser to be manually positioned. The dispenser can be held by the receiving bracket but not fixed to the receiving bracket such that a user can easily dismount the dispenser while the dispenser remains fluidly connected to the dispense manifold to receive the output from the dispense manifold. The dispenser can be toollessly mounted to and removed from the receiving bracket, according to some examples.

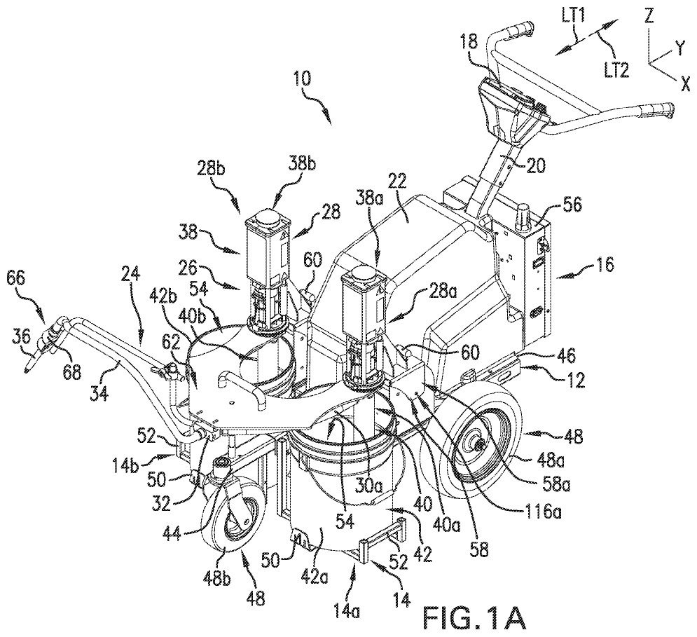

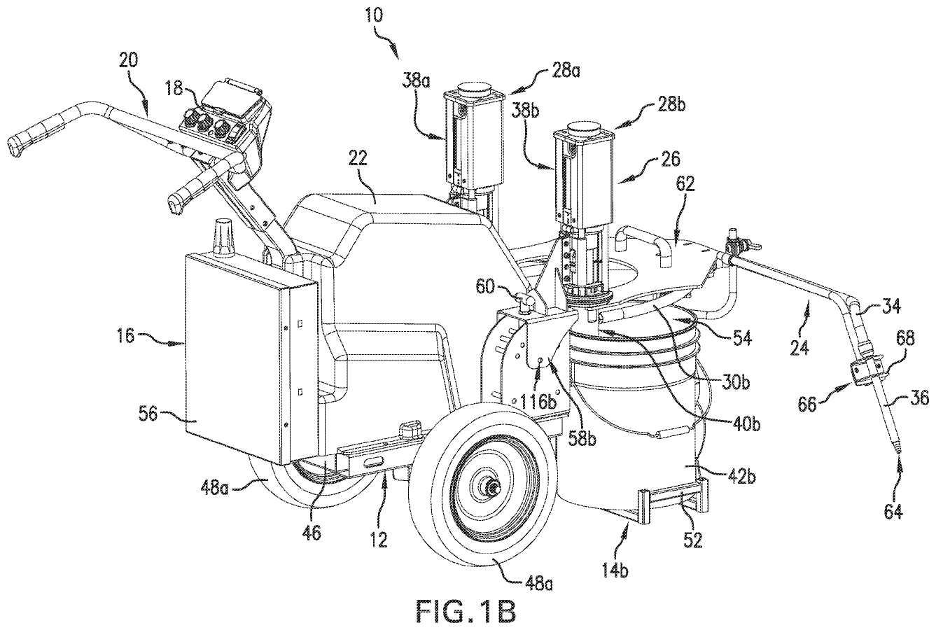

FIG. 1A is a front isometric view of dispense rig 10. FIG. 1B is a rear isometric of dispense rig 10. FIGS. 1A and 1B are discussed together. Dispense rig 10 includes applicator frame 12, supports 14a, 14b (collectively herein “support 14” or “supports 14”), control module 16, user interface 18, control 20, housing 22, dispense support 24, displacers 28a, 28b (collectively referred to herein as “displacer 28” or “displacers 28”), supply lines 30a, 30b (collectively herein “supply line 30” or “supply lines 30”), dispense manifold 32, mix line 34, and dispenser 36,. Displacer 28a includes drive assembly 38a and pump 40a. Displacer 28b includes drive assembly 38b and pump 40b. Drive assemblies 38a, 38b are collectively referred to herein as “drive assembly 38” or “drive assemblies 38”. Pumps 40a, 40b are collectively referred to herein as “pump 40” or “pumps 40”. Material supplies 42a, 42b (collectively referred to herein as “material supply 42” or “material supplies 42”) are shown.

Dispense rig 10 is configured to move along a ground surface and dispense a flooring material for application on the surface. Dispense rig 10, which can also be referred to as a mobile floor surface dispense rig, is configured to mix individual constituent materials together that mix to form a plural component material that is output onto the ground surface. The plural component material is spread on the floor, such as with a spreader, such as a squeegee or roller among other options. The flooring material is formed from two, or more, constituent materials that are stored separately on board the dispense rig 10, pumped and mixed aboard the dispense rig 10, and then dispensed onto the ground surface for spreading and curing. For example, the two constituent materials can be epoxy and/or other curing components and are liquid in form for pumping. The two constituent materials will be generally referred to herein as the first constituent material and the second constituent material, it being understood that a variety of mixed component materials can be used.

An X-Y-Z coordinate plane is shown in FIG. 1A. In the description, the direction Y is considered to be longitudinal, the direction X is considered to be lateral, and the direction Z is considered to be vertical.

Applicator frame 12 supports other components of dispense rig 10. Applicator frame 12 extends longitudinally (along direction Y) between front end 44, which can be referred to as a first longitudinal end, and rear end 46, which can be referred to as a second longitudinal end. Applicator frame 12 extends laterally (along direction X). Applicator frame 12 can be a structure of metal tubes, amongst other options.

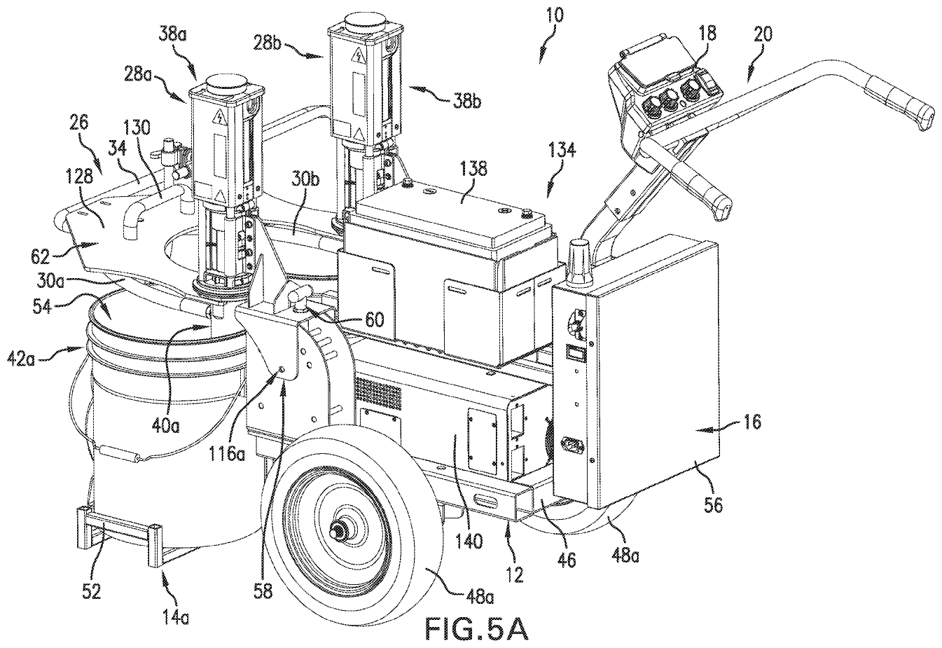

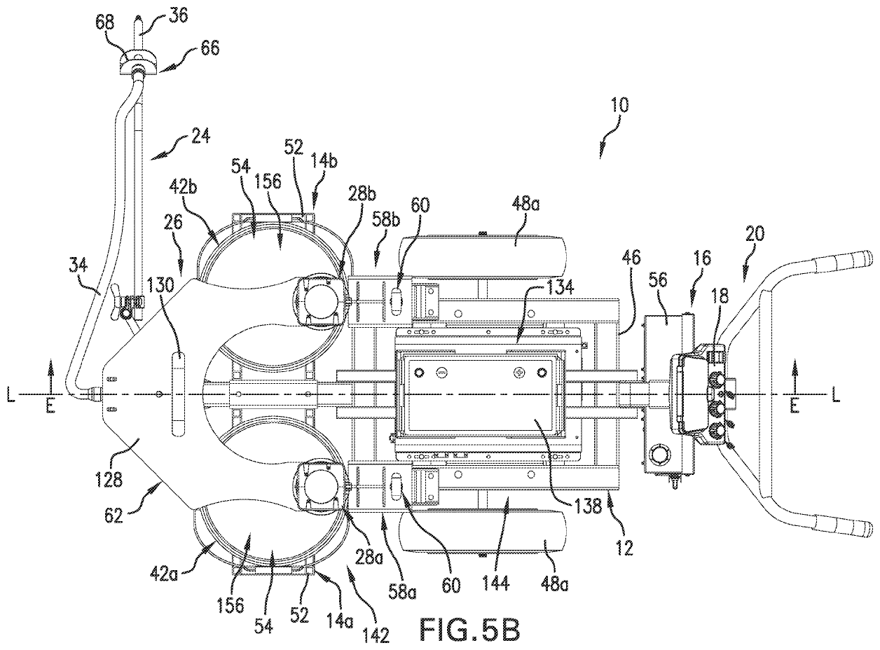

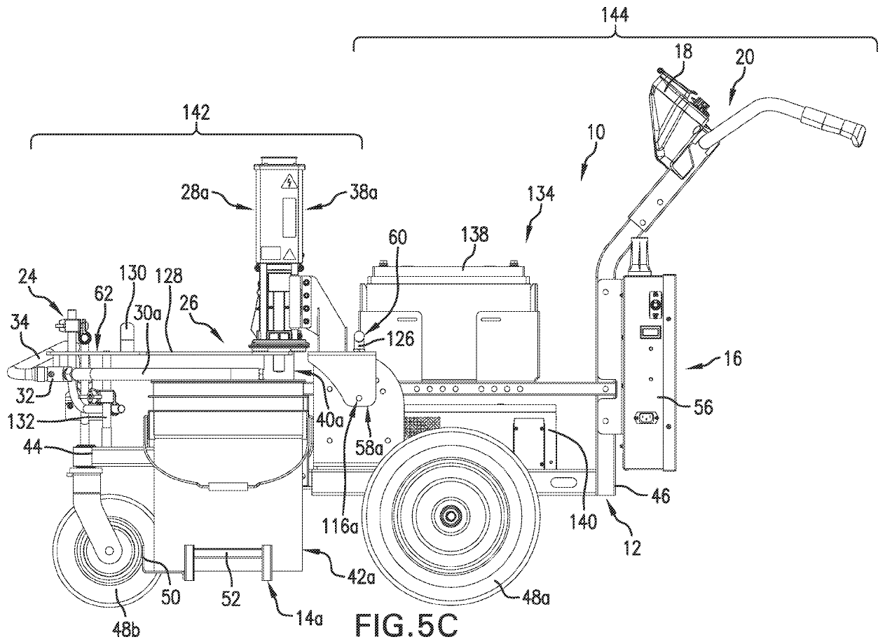

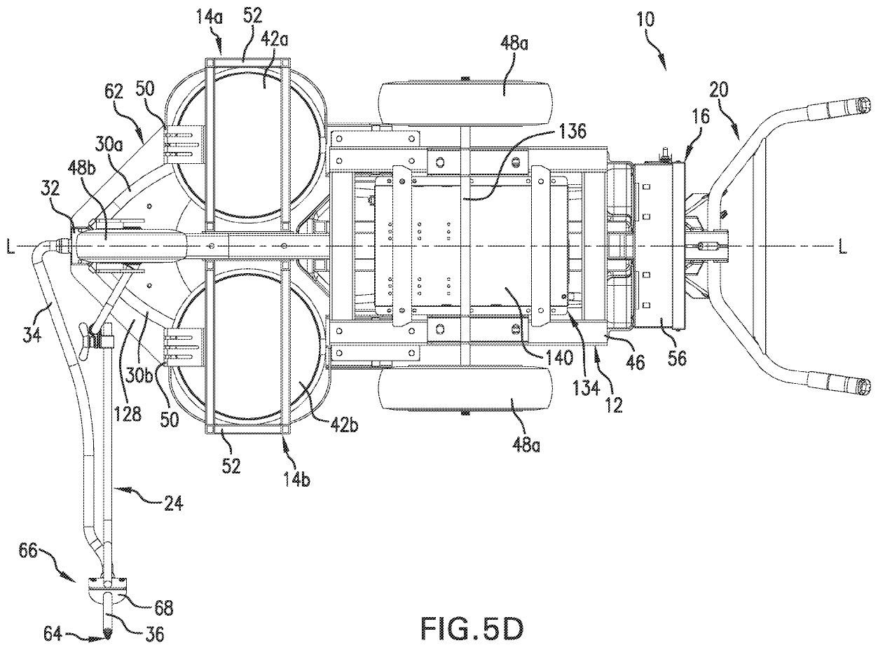

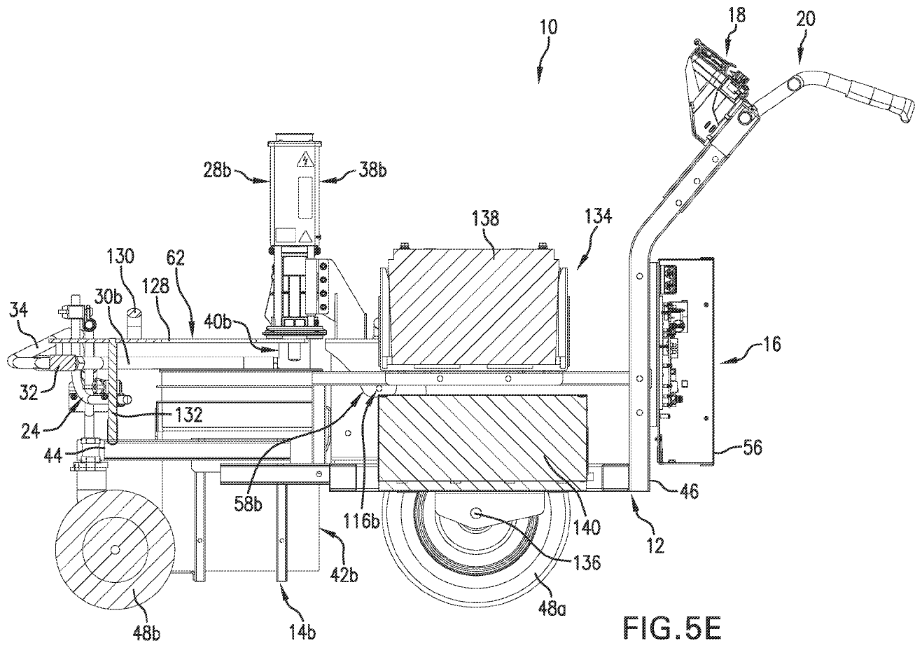

Wheels 48 are connected to applicator frame 12 and are configured to roll along the ground surface to facilitate moving of the dispense rig 10 within a job site and/or between job sites. In the example shown, applicator frame 12 is supported by a pair of rear wheels 48a and a front wheel 48b, though it is understood that not all examples are so limited. Rear wheels 48a can be connected together by an axle or individually mounted to applicator frame 12. In the example shown, rear wheels 48a are connected together by a rear axle. Rear wheels 48a are disposed in a fixed orientation such that rear wheels 48a can roll forwards or backwards but do not pivot about a vertical axis. As such, rear wheels 48a are not formed as caster wheels in the example shown. Front wheel 48b is disposed at front end 44 of applicator frame 12. In the example shown, front wheel 48b is disposed on a longitudinal centerline L-L (FIG. 5B) of applicator frame 12. In the example shown, front wheel 48b is configured to roll along the ground surface and to pivot. Front wheel 48b is formed as a caster wheel that is not disposed in a fixed orientation relative to the applicator frame 12. Front wheel 48b can rotate on a vertical axis for steering of dispense rig 10.

Each material supply 42 is configured to hold a supply of a constituent material for pumping by a pump 40. For example, material supply 42a can store a supply of a first constituent material and material supply 42b can store a supply of a second constituent material. The material supplies 42 can also be referred to as reservoirs.

Supports 14 projects from other portions of applicator frame 12. In some examples, supports 14 can be formed integrally with other portions of applicator frame 12. Supports 14 can be permanently fixed relative to applicator frame 12 (e.g., by welding or monolithic formation). Each support 14 is configured to support a material supply 42. Support 14a projects laterally from a central portion of applicator frame 12. Support 14b projects laterally outward from the central portion of applicator frame 12. Supports 14a, 14b are disposed on opposite lateral sides of the longitudinal centerline L-L of applicator frame 12. Supports 14 can be considered to form portions of applicator frame 12. Support 14a is configured to support material supply 42a. Support 14b is configured to support material supply 42b. Supports 14 support the material supplies 42 such that material supplies 42 ride on supports 14 and move with dispense rig 10. In some examples material supplies 42 can be considered to ride on applicator frame 12. In the example shown, each support 14a, 14b projects vertically below the vertically highest portion of front wheel 48b.

In the example shown, applicator frame 12 is configured such that each material supply 42 is overlapped on four sides by portions of applicator frame 12 to prevent the material supply 42 from shifting laterally or longitudinally off of support 14. In the example shown, each support 14 includes longitudinal flange 50 that inhibits movement of the material supply in first longitudinal direction LT1 and includes lateral flange 50 that inhibits movement of the material supply 42 laterally outward from applicator frame 12. The central portion of applicator frame 12 inhibits movement of the material supply 42 laterally inwards towards the longitudinal centerline L-L. Portions of applicator frame 12 longitudinally rearward of material supply 42 inhibit movement of the material supplies 42 in second longitudinal direction LT2. Applicator frame 12 overlapping with material supplies 42 retains material supplies 42 on applicator frame 12 as dispense rig 10 is moved about a job site.

Material supplies 42 are configured to store supplies of the constituent materials prior to mixing to form the plural component material. Material supply 42a is supported on support 14a. Material supply 42b is supported on support 14b. In the example shown, material supplies 42 are formed as buckets. Each material supply 42 includes a top opening 54 through which constituent material can be withdrawn from the material supply 42. such as by a pump 40, and through which additional constituent material can be added to the material supply 42. For example, a user can pour additional constituent material into the material supply 42 through the top opening 54. As discussed in more detail below, dispense rig 10 is configured such that the top opening 54 is at least partially uncovered with pumps 40 extending into material supplies 42 through the top openings 54 such that constituent material can be added without having to manipulate other components of dispense rig 10. In the example shown, material supplies 42 are formed as 5-gallon buckets, though it is understood that other configurations are possible.

Dispense rig 10 includes control 20. The control 20 can include a steering structure, such as handlebars as shown, a steering wheel, or other structure. The dispense rig 10 can be pushed by the user's hands gripping the control 20 and/or can be pulled by the user's hands gripping the control. Control 20 can include more inputs, which can be electronic inputs, such as buttons or switches, for controlling the displacers 28 to pump the constituent materials to cause dispensing from dispenser 36. Control 20 can include a steering control and one or more inputs that operate the one or more motors to cause the dispenser to dispense the mixture of the first and second constituent materials.

Control module 16 is disposed at a longitudinally rear end of dispense rig 10. Control module 16 includes a module housing 56 configured to house control components, such as memory and processor among other electronic control components, of the dispense rig 10.

Housing 22 is supported by applicator frame 12. Housing 22 is disposed laterally between rear wheels 48. Housing 22 extends longitudinally and vertically. Housing 22 can be considered to form a shroud of a power supply of dispense rig 10. Housing 22 at least partially encloses the power supply of dispense rig 10, as discussed in more detail below. In some examples of dispense rig 10 the power supply includes one or more batteries for powering electric components of dispense rig 10. In such an example, housing 22 can be considered to form a battery bay of dispense rig 10.

Displacers 28 are supported by applicator frame 12. Displacers 28 are configured to draw the constituent materials from material supplies 42 and drive the constituent materials downstream under pressure to dispenser 36 for dispensing from dispense rig 10. For each displacer 28, drive assembly 38 is mounted to applicator frame 12 and pump 40 is connected to drive assembly 38 to be powered to pump by drive assembly 38. As discussed in more detail below, each drive assembly 38 includes an electric motor configured to generate a rotational output and includes a drive configured to convert the rotational output to a linear reciprocating input provided to the pump 40 of that displacer 28 to power the pump 40 of that displacer 28.

In the example shown, displacers 28 are movably mounted to applicator frame 12. Each displacer 28 is movable to place the displacer 28 in a respective immersed state, in which the displacer 28 is positioned to pump the constituent materials from the material supply, and a respective stowed state, in which the displacer 28 is withdrawn from the material supply 42, such as to facilitate removal and/or replacement of the material supply 42.

Displacers 28a, 28b are respectively connected to applicator frame 12 by mount brackets 58a, 58b (collectively herein “mount bracket 58” or “mount brackets 58”) in the example shown. Mount bracket 58a is mounted to applicator frame 12 and connected to displacer 28a. Mount bracket 58b is mounted to applicator frame 12 and connected to displacer 28b. Mount brackets 58 are connected to drive assemblies 38 and to applicator frame 12. Mount brackets 58 support the displacers 28 in both the respective immersed states and the respective stowed states. Mount brackets 58 can facilitate movement of the displacers 28 relative to the applicator frame 12 as the displacers 28 move between the respective immersed and stowed states.

Each of the first pump 40a and the second pump 40b are driven by independent motors 70 for which the respective speeds can be changed to change the output from the pumps 40a, 40b. The pumps 40a, 40b can be sized for a common displacement but can be controlled for any desired mix ratio. For example, pumps 40a, 40b can be controlled to output constituent materials at a 1:1 mix ratio, regardless of whether the pumps 40a, 40b are commonly sized by controlling operation of the electric motors 70. Pumps 40a, 40b can be controlled for mix ratios that are 1:1 or 1: X wherein X is not 1. For example, the electric motors 70 can be controlled to provide a mix ratio other than 1:1 even when the pumps 40 are commonly sized. The output ratio from the pumps 40a, 40b can be electrically controlled by respective motors 70 driving the respective pumps 40a and 40b.

In the example shown, displacers 28 are configured to pivot between the respective immersed states and stowed states, as discussed in more detail below. It is understood, however, that not all examples are so limited. For example, displacers 28 can be mounted to applicator frame 12 such that displacers 28 elevate between the respective immersed and stowed states. In such an example, displacers 28 can be moved by a rack and pinion connection, a pully assembly, one or more pistons (e.g., pneumatic pistons), among other options.

Position lock 60 is configured to interface with a displacer 28 and applicator frame 12 to secure the displacer 28 in a desired state. In the example shown, position lock 60 interfaces with a mount bracket 58 and with applicator frame 12 to lock displacer 28 in a state. The position lock 60 engages with the applicator frame 12 to hold the displacer 28 in the respective immersed state, with the pump 40 extending into the material supply 42, and in the respective stowed states, with the pump 40 withdrawn from the material supply 42. In the example shown, position lock 60 is formed as a spring-biased lock that is biased into engagement with the applicator frame 12 by a spring. In the example shown, a position lock 60 is associated with each mount bracket 58 to fix a position of that mount bracket 58 on the applicator frame 12. As such, each displacer 28 is individually lockable in a desired state. In the example shown, each drive assembly 38 can be individually retained in the position associated with the stowed state even with pumps 40 dismounted from drive assemblies 38.

Pumps 40 are configured as immersion pumps that extend into a respective material supply 42. The pumps 40 are configured to draw constituent material from the material supply 42 and drive the material downstream to dispenser 36. Pumps 40 extend into material supplies 42 through the top openings 54 of the material supplies 42. Pumps 40 can be of any desired configuration suitable for pumping the constituent materials. For example, pumps 40 can be piston pumps among other options. In the example shown, pumps 40 are removably mountable to the drive assemblies 38 such that pumps 40 can be dismounted from drive assemblies 38 and mounted to drive assemblies 38, as discussed in more detail below. Pumps 40 are formed as immersion pumps in that pumps 40 extend into material supplies 42 and contact the constituent materials. The pumps 40 extend into an associated material supply 42 such that a lower end of the pump 40 is immersed in the constituent material within the material supply 42. In some examples, at least one dynamic seal of a pump 40 is disposed below the top opening 54 and within the material supply 42 with the pump 40 in the immersed state. In some examples, at least one valve of a pump 40 is disposed below the top opening 54 and within the material supply 42 with the pump 40 in the immersed state. In some examples, a rigid intake of a pump 40 is disposed below the top opening 54 and within the material supply 42 with the pump 40 in the immersed state. In some examples, at least a portion of a rigid pump housing 88 of the pump 40 is immersed in the constituent material with the pump 40 in the immersed state.

In the example shown, pumps 40 are fixed together for simultaneous movement between immersed and stowed states. Pumps 40 are further fixed together for simultaneous mounting and dismounting to drive assemblies 38. In the example shown, pump 40a and pump 40b can be considered to form a single pumping assembly such that pump 40a and pump 40b are mountable together as the single pumping assembly and dismountable together as the single pumping assembly.

Connecting bracket 62 extends between and connects displacers 28. In the example shown, connecting bracket 62 extends between and is connected to each pump 40. Connecting bracket 62 is not directly connected to either drive assembly 38 in the example shown. Connecting bracket 62 can be considered to fix pumps 40 together. Connecting bracket 62 facilitates simultaneous movement of displacers 28 between the respective immersed and stowed states. The connecting bracket 62 extends between and fixes pumps 40 together and each pump 40 is mounted to a drive assembly 38. Connecting bracket 62 thereby indirectly fixes drive assemblies 38 together for simultaneous movement between the immersed and stowed states. Connecting bracket 62 being connected to pumps 40 further facilitates simultaneous mounting of pumps 40 to drive assemblies 38 and simultaneous dismounting of pumps 40 from drive assemblies 38.

Supply lines 30 are connected to the outlets of each pump 40. Supply line 30a is connected to the outlet of pump 40a and is configured to receive the first constituent material output by pump 40a. Supply line 30b is connected to the outlet of pump 40b and is configured to receive the second constituent material output by pump 40b. In the example shown, supply lines 30 are supported by connecting bracket 62. Each supply line 30 extends between and fluidly connects a pump 40 with dispense manifold 32. Supply line 30a is connected to a first intake of dispense manifold 32 and supply line 30b is connected to a second intake of dispense manifold 32.

Dispense manifold 32 is configured to receive discrete flows of constituent materials and output the flows to a single mix line 34. In the example shown, dispense manifold 32 is mounted to connecting bracket 62. Dispense manifold 32 includes a single fluid outlet at which mix line 34 is connected to dispense manifold 32. In the example shown, the constituent materials do not mix within the dispense manifold 32 itself. Instead, the constituent materials are maintained as fluidly separate within the dispense manifold 32 and are routed to the common fluid outlet through which both constituent materials are output to mix line 34. It is understood that, in some examples, the constituent materials can mix within the dispense manifold 32 to have at least partially combined within the dispense manifold 32 before being output to the mix line 34. Dispense manifold 32 can also be referred to as a mix manifold.

In some examples, dispense manifold 32 can include one or more valves that are pressure actuated to prevent cross-over of constituent materials which could cause mixing and curing in supply lines 30. For example, dispense manifold 32 can include a first valve associated with a first flowpath through dispense manifold 32 that directs a first constituent material from supply line 30a to mix line 34. The first valve can be pressure actuated such that pressure generated by pump 40a opens the first valve. Dispense manifold 32 can include a second valve associated with a second flowpath through dispense manifold 32 that directs a second constituent material from supply line 30b to mix line 34. The second valve can be pressure actuated such that pressure generated by pump 40b opens the second valve.

Mix line 34 is connected to the fluid outlet of the dispense manifold 32. Mix line 34 extends between and fluidly connects dispense manifold 32 and dispenser 36. Mix line 34 is configured to convey a mixture of the first and second constituent materials to the dispenser 36 for output as the plural component material. Dispenser 36 is configured to output the plural component material on the ground surface. The plural component material exits from dispense rig 10 through a nozzle of the dispenser 36.

Dispenser 36 is supported by dispense support 24. Dispenser 36 includes mixing components that are configured to encourage mixing of the constituent materials as the constituent materials flow through dispenser 36. Dispenser 36 can also be considered to form a static mixer. Dispenser 36 includes a nozzle 64 through which the plural component material is output for application on the ground surface.

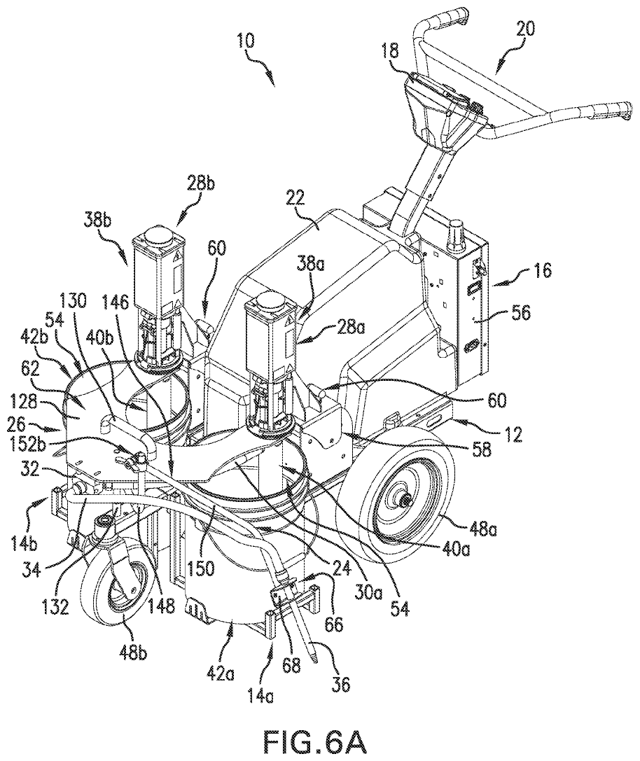

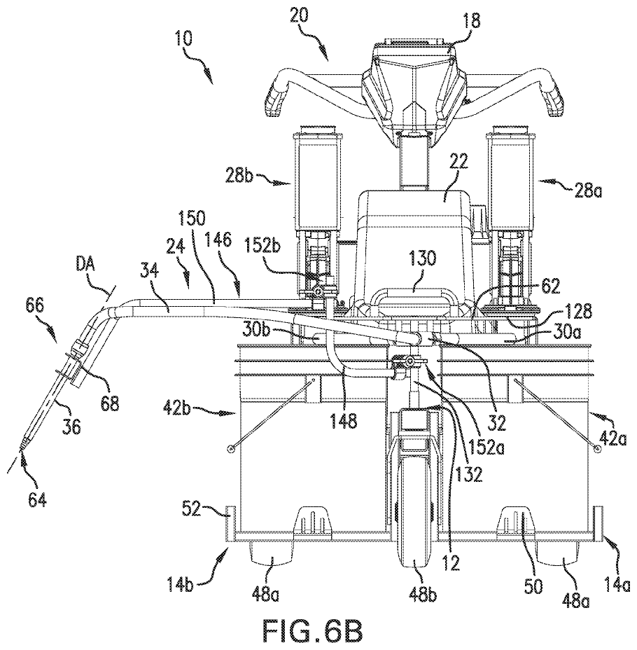

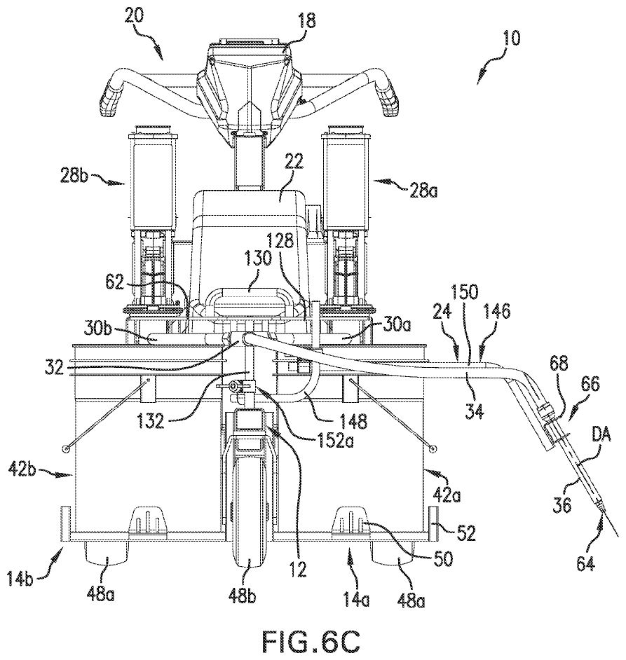

Dispense support 24 is configured to support dispenser 36 relative to the ground surface. In the example shown, dispense support 24 is connected to connecting bracket 62 to be supported by connecting bracket 62. Dispense support 24 is repositionable relative to applicator frame 12 to position dispenser 36 at a desired location for outputting the plural component material. For example, dispense support 24 can pivot about the front end 44 of applicator frame 12 to position dispenser 36 on either lateral side of dispense rig 10. In the example shown in FIGS. 1A and 1B, dispense support 24 is oriented to position dispenser 36 on the right lateral side of dispense rig 10, but dispense support 24 can be pivoted to reposition dispenser 36 on the left lateral side of dispense rig 10 (best seen in FIGS. 6A and 6C). The dispenser 36 can be selectively repositioned on either a left lateral side or a right lateral side of the dispense rig. In some examples, dispense support 24 is vertically repositionable such that the nozzle of dispenser 36 can be positioned closer to or further from the ground surface. In some examples, dispense support 24 is movable to reorient the nozzle 64 of dispenser 36. For example, dispenser 36 can be rotatably repositioned about an axis of the dispense support 24 to reposition nozzle 64 vertically, horizontally, or at an orientation therebetween. In some examples, dispense support 24 is movable such that dispenser 36 can be adjusted forwards and backwards in addition to side to side, such that dispenser 36 can be moved closer to or further from applicator frame 12.

Receiver 66 is disposed at an end of dispense support 24 and is configured to interface with dispenser 36 to support dispenser 36. In the example shown, receiver 66 includes receiving bracket 68 that interfaces with dispenser 36. Receiving bracket 68 includes a pair of openings through which the dispenser 36 extends with the dispenser 36 mounted to dispense support 24. In the example shown, dispenser 36 can be toollessly mounted to and dismounted from receiver 66. For example, dispenser 36 can be removed from receiver 66 to be positioned and held by the user, such as over a bucket when pumping solvent for cleaning of fluid-handling components of dispense rig 10 or for dispensing plural component material in hard to reach locations. In the example shown, dispenser 36 is removable from receiving bracket 68 by pulling dispenser 36 along dispense axis DA (FIGS. 6B and 6C) and out of receiving bracket 68 and dispenser 36 is mountable to receiving bracket 68 by aligning dispenser 36 with the openings of receiving bracket 68 and shifting dispenser 36 along dispense axis DA and through the openings of receiving bracket 68.

Displacers 28 only partially cover the top openings 54 of material supplies 42 during operation of dispense rig 10. In some examples, the top opening 54 of a material supply 42 is at least 20% exposed with an associated displacer 28 in the immersed state. In some examples, the top opening 54 of the material supply 42 is at least 35% exposed with an associated displacer 28 in the immersed state. In some examples, the top opening 54 of material supply 42 is at least 50% exposed with an associated displacer 28 in the immersed state. Such a configuration facilitates pouring of additional constituent materials into the material supplies 42 without having to remove pumps 40 and without having to remove and replace the material supply 42 itself. Such a configuration reduces downtime as the material supplies 42 are accessible for quick and easy refilling without requiring manipulation of other components of dispense rig 10. The top opening 54 can be considered to be exposed when not vertically overlapped by other components of dispense rig 10.

Supports 14 are disposed at the longitudinal front end of dispense rig 10. Supports 14 can be considered to be disposed at the front corners of dispense rig 10. Supports 14 position material supplies 42 such that material supplies 42 are accessible from longitudinally forward of material supplies 42 and laterally outward of material supplies 42 for refilling through top opening. In the example shown, at least a portion of the top opening 54 that is uncovered with displacers 28 in the immersed states is disposed on the laterally outer portion of the top opening 54. Having a laterally outward portion of the top opening 54 uncovered facilitates pouring of refill constituent material into the material supply 42 without having to reach the constituent material over other components (e.g., over connecting bracket 62) at which location the constituent materials can drip onto those components. Having the laterally outer portion of top opening 54 uncovered facilitates clean and quick refilling of material supplies 42. In the example shown, the laterally outward uncovered portion can form up to about 15% of the area of the top opening 54, up to about 20% of the top opening 54, up to about 25% of the top opening 54, up to about 35% of the area of the top opening 54, up to about 50% of the area of the top opening 54, or more of the area of the top opening 54.

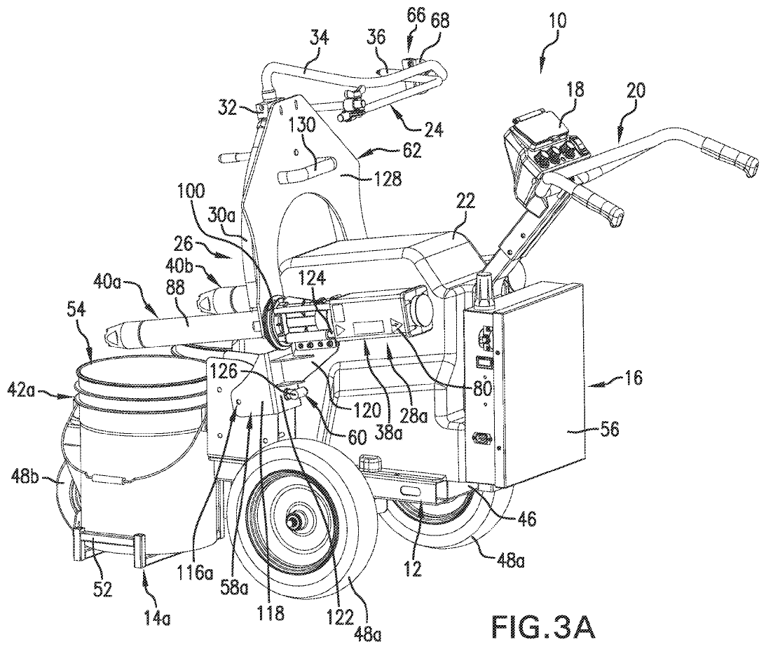

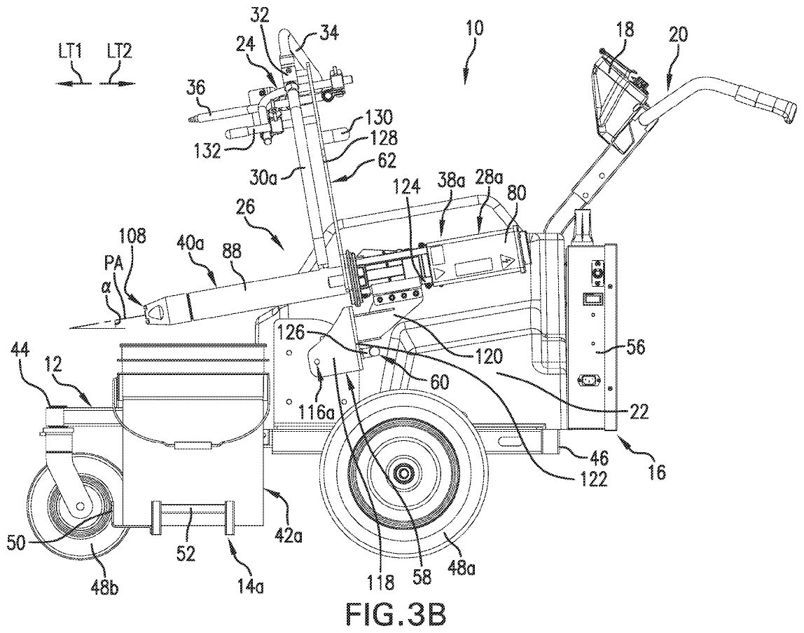

During operation, dispense rig 10 is utilized to emit a floor surface material onto a ground surface which material is cured in place to form the floor surface. Displacers 28 are in the respective stowed states (FIGS. 3A and 3B). Material supply 42a is placed on support 14a and in the area between the lateral and longitudinal retaining portions of support 14a. Material supply 42b is placed on support 14b and in the area between the lateral and longitudinal retaining portions of support 14b. The lateral and longitudinal retaining portions of supports 14 maintain material supplies 42 mounted on applicator frame 12 as dispense rig 10 is traversed about a job site.

Displacers 28 are moved relative to applicator frame 12 such that displacers 28 shift from the respective stowed states to the respective immersed states. Pumps 40 extend into material supplies 42 through the top openings 54 of each material supply 42. With displacers 28 in the respective immersed states, at least a portion of each pump 40 is in contact with the constituent materials held in the material supplies.

If previously dismounted, mix line 34 is connected to the fluid outlet of dispense manifold 32. Dispenser 36 can be mounted to receiver 66 or can be held in the hand of a user for aiming during output of material. Displacer 28 is mounted to receiver 66 by shifting displacer 28 through the bracket openings of receiving bracket 68 such that displacer 28 extends through each of the pair of bracket openings of receiving bracket 68.

Dispense support 24 is positioned relative to applicator frame 12 to position the dispenser 36 at a desired location relative to applicator frame 12. Dispense support 24 can be shifted vertically to position dispenser 36 vertically closer or vertically further from the ground surface and/or can be pivoted about the front end 44 of applicator frame 12 to position dispenser 36 at a desired location about the front end 44 of applicator frame 12. For example, the dispense support 24 can be pivoted to position the dispenser 36 on the left lateral side of the applicator frame 12, on the right lateral side of the applicator frame 12, or at locations therebetween.

With the dispenser 36 positioned and fluidly connected to the dispense manifold 32, the dispense rig 10 is ready to dispense. The operator can grasp control 20 and push dispense rig 10 longitudinally forward or pull dispense rig longitudinally rearward during dispense operations. The drive assemblies 38 are powered by the power supply and drive operation of pumps 40. Pump 40a is powered by drive assembly 38a and pumps the first constituent material from material supply 42a through supply line 30a and to dispense manifold. Pump 40b is powered by drive assembly 38b and pumps the second constituent material from material supply 42b through supply line 30b and to dispense manifold 32. The first and second constituent materials are output from dispense manifold through the single fluid outlet and flow to and through mix line 34. The first and second constituent materials can mix within mix line 34 and flow to dispenser 36. Dispenser 36 can be a static mixer that further mixes the first and second constituent materials to form the plural component flooring material. The plural component material is output through the nozzle 64 of the dispenser 36 and applied to the ground surface. A user can spread the plural component flooring material on the ground surface as desired before curing.

Dispense rig 10 provides significant advantages. Material supplies 42 are supported by applicator frame 12 to move with dispense rig 10. Pumps 40 are configured as immersion pumps that extend into the material supplies 42, reducing the length of fluid lines that convey the first and second constituent materials. The pumps 40 being formed as immersion pumps reduces length of fluid lines that require cleaning between dispense operations and facilitates maintenance of desired pressure by reducing the lengths of flexible hosing that are included on dispense rig 10. Such flexible hosing can flex in response to pressure, accumulating pressure. The setup of dispense rig 10 as a cart allows the dispense rig 10 to dispense and move along the floor surface at the same time.

The wetted components of dispense rig 10, including pumps 40, supply lines 30, dispense manifold 32, mix line 34, and dispenser 36, are mountable and removable as a single unit. Such a configuration allows for simple and easy replacement of the wetted portions of dispense rig 10, such as for use with different constituent materials, which eliminates the potential for cross-contamination between such different constituent materials.

Supports 14 are disposed on opposite lateral sides of the centerline L-L of applicator frame 12. The supports 14 form the longitudinally forwardmost portions of applicator frame 12 on the opposite lateral sides of the centerline L-L. Supports 14 can be considered to form the longitudinally forwardmost lateral corners of the applicator frame 12. Positioning the supports 14 at longitudinally forward positions places material supplies 42 at locations that are easily accessible by the user. The user is able to place material supplies 42 on supports and remove material supplies 42 off of supports 14 from either laterally outward from applicator frame 12 or longitudinally forward from applicator frame 12. Such positioning reduces user fatigue and provides for a simpler system. Further, the positioning of supports 14 provides for easy access for the user to add additional material to the material supplies 42 through the uncovered portions of the top openings 54 even when the displacers 28 are in the respective immersed states.

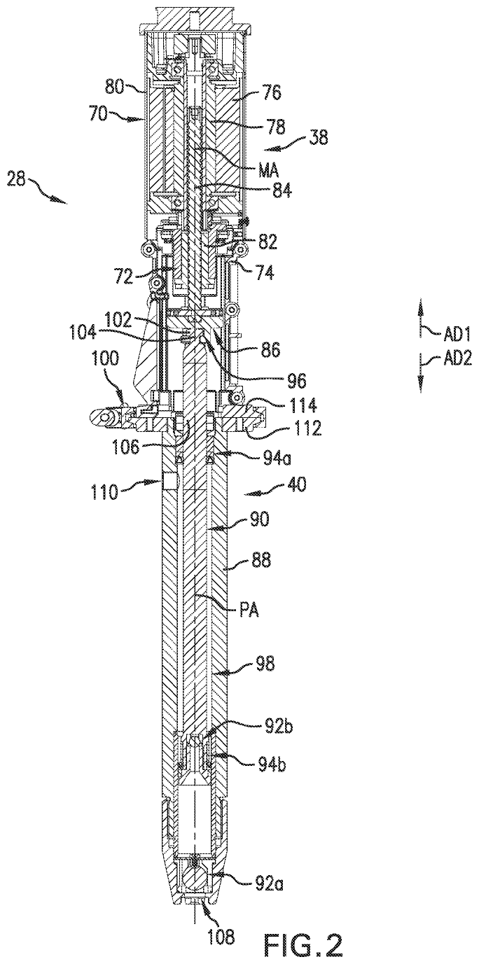

FIG. 2 is a cross-sectional view of a displacer 28. Displacer 28 includes drive assembly 38 and pump 40. Drive assembly 38 includes motor 70, drive 72, and drive body 74. Motor 70 includes stator 76, rotor 78, and motor housing 80. Drive 72 includes rotator 82, linear mover 84, and connector 86. Pump 40 includes pump housing 88, piston 90, valves 92a, 92b, dynamic seal 94a, and dynamic seal 94b.

Displacer 28 is configured to draw constituent material from a material supply 42 and drive the constituent material downstream to dispenser 36 for dispensing from dispense rig 10. Drive assembly 38 is configured to drive pumping by pump 40. Drive assembly 38 is configured to mount to applicator frame 12 such that drive assembly 38 is connected to applicator frame 12.

Drive body 74 supports and at least partially encloses components of drive assembly 38. In the example shown, drive body 74 includes motor housing 80 that extends about and at least partially encloses motor 70. Drive body 74 extends axially beyond motor 70 in second axial direction AD2 and is configured to enclose the dynamic interface formed between drive 72 and piston 90.

Motor 70 is an electric motor configured to receive electrical power signals and generate a rotational output. Stator 76 electromagnetically drives rotation of rotor 78 on the motor axis MA. In the example shown, rotor 78 is disposed radially within stator 76. As such, motor 70 can be considered to form an inner rotator. It is understood, however, that motor 70 can be configured such that stator 76 is disposed radially within rotor 78, such that motor 70 is considered to form an outer rotator. In the example shown, motor 70 is configured such that rotor 78 can be driven to rotate in either of two rotational directions, clockwise on motor axis MA or counterclockwise on motor axis MA. Motor housing 80 is disposed around and at least partially encloses stator 76 and rotor 78.

Drive 72 is operably connected to motor 70. Drive 72 is connected to rotor 78 of motor 70 to receive the rotational output from the rotor 78. Drive 72 is configured to convert the rotational output from motor 70 into linear reciprocating motion. Rotator 82 of drive 72 is connected to rotor 78 to receive the rotational output from motor 70. In the example shown, rotator 82 is formed as a drive nut that receives the rotational output. Linear mover 84 interfaces with rotator 82. Linear mover 84 is configured to displace linearly along pump axis PA by rotation of the rotator 82. In the example shown, linear mover 84 is formed as a screw that is driven linearly by rotation of the drive nut forming rotator 82. In some examples, rolling elements, such as balls or elongate rollers, can be disposed between and interface with the rotator 82 and linear mover 84 to drive linear displacement of the linear mover 84 based on rotation of the rotator 82.

Connector 86 is connected to linear mover 84 to move with linear mover 84. Connector 86 can be formed integrally with linear mover 84, such as a monolithic piece, or can be formed separately from and connected to linear mover 84. Connector 86 includes slot 96 that is open radially and open in second axial direction AD2 along pump axis PA. Connector 86 can be considered to form a slotted connector in the example shown.

Pump 40 is mountable to and dismountable from drive assembly 38. Pump housing 88 defines a fluid chamber 98 through which constituent material is pumped during pumping. Pump housing 88 can be formed as a cylinder, among other options. Pump housing 88 is configured to mount to drive body 74 to secure pump 40 to drive assembly 38. In the example shown, pump housing 88 is mounted to drive body 74 by a clamp 100 that extends at least partially around drive body 74 and pump housing 88. The clamp 100 is configured to secure the pump housing 88 to the drive body 74 such that pump 40 and drive assembly 38 are fixed together.

Piston 90 is at least partially disposed within pump housing 88. Piston 90 extends out of pump housing 88 in first axial direction AD1. Piston 90 is configured to reciprocate along pump axis PA to pump the constituent material. Piston head 102 is disposed at a first axial end of piston 90. Piston neck 104 extends between piston head 102 and piston shaft 106. Piston head 102 is configured to be received within slot 96 to connect piston 90 to drive 72. Piston neck 104 projects through slot 96 of connector 86 and out of slot 96 in second axial direction AD2. Piston neck 104 extends between and connects piston head 102 and piston shaft 106.

Dynamic seal 94a interfaces with piston shaft 106 and forms a fluid seal between piston 90 and pump housing 88. Piston 90 is configured to reciprocate relative to dynamic seal 94a during operation of pump 40. Dynamic seal 94b interfaces with piston 90 and pump housing 88 to form a fluid seal between piston 90 and pump housing 88. In the example shown, dynamic seal 94b is mounted to piston 90 to reciprocate with piston 90. During operation, dynamic seal 94b is disposed within material supply 42 below the top opening 54 with displacer 28 in the immersed state.

Valve 92a is disposed at an axial end of the pump housing 88. Valve 92a can be considered to form an intake valve of pump 40. Valve 92a is configured to regulate flow of constituent material into the fluid chamber 98 within pump housing 88. Valve 92a prevents retrograde flow out of the pump inlet 108 of pump 40. Valve 92a can also be referred to as an intake valve of the pump 40.

Valve 92b is disposed within piston 90. Valve 92b is at an opposite axial end of piston 90 from piston head 102. Valve 92b is configured to prevent retrograde flow from a downstream chamber of fluid chamber 98 to an upstream chamber of fluid chamber 98, the upstream chamber formed between valve 92a and valve 92b.

Pump inlet 108 is formed at an axial end of pump housing 88 opposite the axial end that piston 90 extends out of. The pump inlet 108 is disposed on pump axis PA along which piston 90 reciprocates. Constituent material enters into pump 40 through pump inlet 108.

Pump inlet 108 is formed as an opening through the rigid structure of pump housing 88. Pump inlet 108 is not formed as a flexible tube in the example shown. It is understood that, in some examples, a flexible tube may extend from pump inlet 108, but the pump inlet 108 itself is formed in a rigid body in the example shown. Pump inlet 108 can be considered to form a rigid inlet of pump 40 in the example shown. Pump outlet 110 is formed through pump housing 88. In the example shown, pump outlet 110 is formed as a radial bore through pump housing 88. Pump outlet 110 is disposed axially between dynamic seals 94a, 94b in the example shown. A supply line 30 is configured to connect to pump 40 at pump outlet 110 to receive the constituent material output by pump 40.

In the example shown, pump axis PA and motor axis MA are aligned to form a common axis of the displacer. As such, the rotational axis of the electric motor 70 is disposed coaxially with the pump axis PA along which piston 90 reciprocates. It is understood, however, that not all examples are so limited. Further, while drive 72 is shown as aligned on the common axis, it is understood that not all examples are so limited. For example, motor axis MA can be disposed orthogonal to pump axis PA. In such an example, drive 72 can be formed as an eccentric or other device suitable for converting the rotational output from motor 70 to a linear reciprocating input to piston 90.

Pump 40 is removably mountable to drive assembly 38. In the example shown, pump 40 is mounted to and dismounted from drive assembly 38 by shifting pump 40 radially relative to the pump axis PA. The pump 40 interfaces with drive assembly 38 at a dynamic interface and at a static interface. The dynamic interface is formed between piston 90 and drive 72 and provides motion to piston 90 to drive displacement of piston 90. The static interface is formed between pump housing 88 and drive body 74 and structurally connects pump 40 to drive 72 such that pump 40 is supported by drive 72.

An example of mounting pump 40 to drive assembly 38 and dismounting pump 40 from drive assembly 38 is discussed in more detail. With pump 40 initially dismounted from drive assembly 38, piston 90 is aligned with slot 96 and pump 40 is shifted radially relative to pump axis PA. Pump 40 is shifted such that piston head 102 enters into slot 96 of connector 86. Connector 86 is formed such that portions of connector 86 can interface with a bottom side of piston head 102 oriented in second axial direction AD2 and such that portions of connector 86 can interface with one or the other of a top side of piston head 102 oriented in first axial direction ADI or a shoulder of piston shaft 106 extending between piston shaft 106 and piston neck 104. The interfaces between piston 90 and connector 86 transmit driving forces from drive 72 to piston 90 to cause reciprocation of piston 90.

A top side of pump plate 112 of pump housing 88, facing in first axial direction AD1, is disposed below and interfaces with a bottom side of drive plate 114 of drive body 74, facing in second axial direction AD2. The interface between pump plate 112 and drive plate 114 can form the static interface between pump 40 and drive assembly 38. Clamp 100 is secured around pump plate 112 and drive plate 114 to secure pump housing 88 to drive body 74. In some examples, drive body 74 includes a movable door that can be opened to allow for mounting and dismounting of pump 40. The clamp 100 can secure the door in a closed state with pump 40 mounted to drive assembly 38.

To dismount pump 40 from drive assembly 38, the clamp 100 is removed, detaching pump housing 88 from drive body 74. Pump 40 can then be shifted radially relative to pump axis PA to remove piston head 102 from slot 96. With piston head 102 removed from slot 96, the pump 40 is dismounted and the same or a different pump 40 can be mounted to drive assembly 38.

Displacer 28 provides significant advantages. Pump 40 is mountable to and removable from drive assembly 38 as a single unit. The pump 40 mounts to drive assembly 38 at dynamic and static interfaces that can be simultaneously aligned and broken. Piston head 102 mounts to and dismounts from connector 86 by sliding within slot 96. The dynamic connection can be formed and broken by simple sliding of piston head 102 relative to connector 86 and within slot 96. Pump 40 can be mounted and dismounted by disconnecting clamp 100 and then shifting of pump 40 radially, which facilitates quick and simple assembly and disassembly of displacer 28, reducing downtime and increasing operational efficiency.

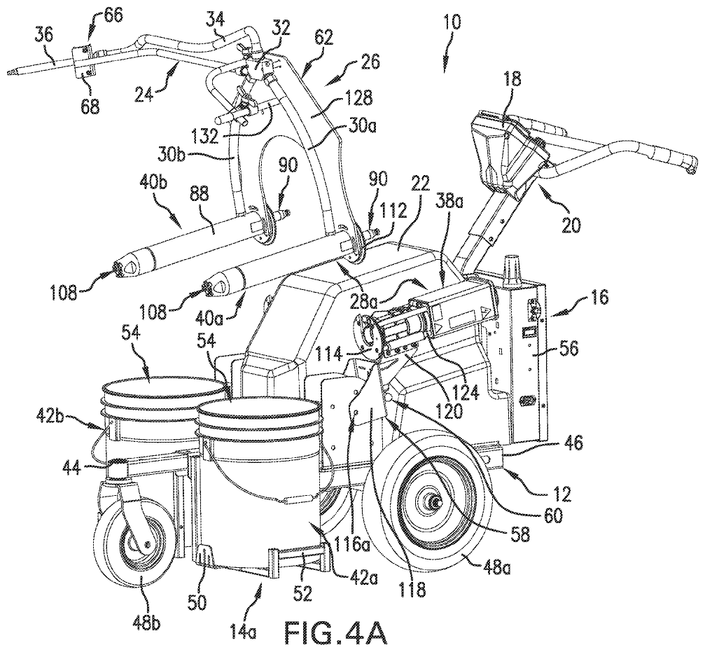

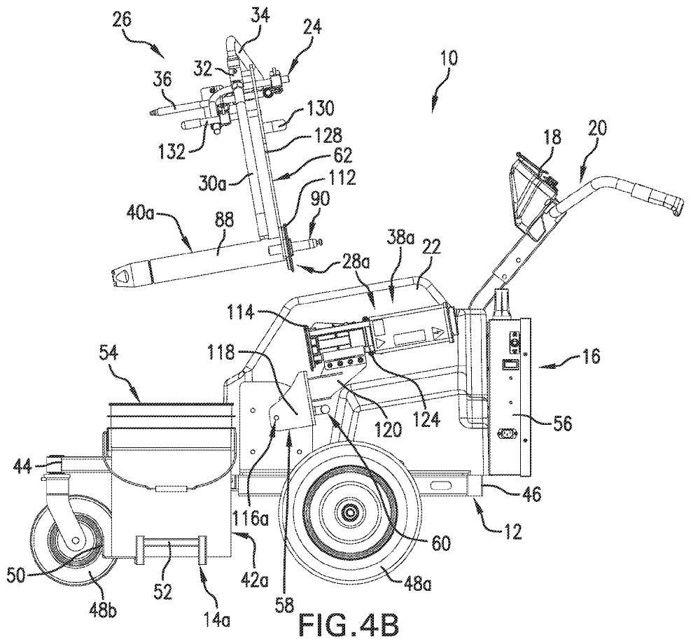

FIG. 3A is an isometric view of dispense rig 10 showing displacers 28a, 28b in the respective stowed states. FIG. 3B is an elevational side view of dispense rig 10 showing displacers 28a, 28b in the respective stowed states. FIG. 4A is an isometric view of dispense rig 10 showing fluid handling assembly 26 of dispense rig 10 dismounted relative to other portions of dispense rig 10. FIG. 4B is an isometric view of dispense rig 10 showing fluid handling assembly 26 of dispense rig 10 dismounted relative to other portions of dispense rig 10. FIGS. 3A-4B are discussed together.

Displacers 28 are movable relative to applicator frame 12 to place displacers 28 in respective immersed states (FIGS. 1A and 1B) and to place displacers 28 in respective stowed states (FIGS. 3A and 3B). The pumps 40 are elevated out of the material supplies 42 with the displacers 28 in the respective stowed states.

Each displacer 28 is mounted to applicator frame 12 and supported by applicator frame 12. In the example shown, displacer 28a is mounted to applicator frame 12 by mount bracket 58a and displacer 28b is mounted to applicator frame 12 by mount bracket 58b. Mount bracket 58a is mounted to applicator frame 12 at pivot 116a. The pivot 116a can be formed as a bearing pivot that supports rotation of the mount bracket 58a about the pivot 116a. In the example shown, mount bracket 58a includes a pair of pivot arms 118 that are each mounted to applicator frame 12. The pivot 116a extends through each pivot arm 118 such that each pivot arm 118 is mounted to applicator frame 12 at a discrete pivot. Mount bracket 58b is mounted to applicator frame 12 at pivot 116b. The pivot 116b can be formed as a bearing pivot that supports rotation of the mount bracket 58b about the pivot 116b. In the example shown, mount bracket 58b includes a pair of pivot arms 118 that are each mounted to applicator frame 12. The pivot 116b extends through each pivot arm 118 such that each pivot arm 118 is mounted to applicator frame 12 at a discrete pivot.

Each mount bracket 58 is connected to the drive assembly 38 of a displacer 28. The mount bracket 58 interfaces with the drive body 74 of the drive assembly 38 in the example shown. A mount arm 120 extends from a base plate 122 of the mount bracket 58 to interface with the drive assembly 38. The pivot arms 118 extend from one side of the base plate 122 to interface with the applicator frame 12 and the mount arm 120 extends from an opposite side of the base plate 122 from the pivot arms 118. The mount arm 120 is disposed laterally between the pivot arms 118.

In the example shown, the mount bracket 58 connects to one or more connecting rods 124 that form a portion of the drive body 74 of the drive assembly 38. In the example shown, each mount bracket 58 is connected to a pair of connecting rods 124. The connecting rods 124 extend between and connect the motor housing 80 and the drive plate 114. The drive body 74 can include a guard that is movable to cover and uncover the area within drive body 74 at which the piston 90 interfaces with the connector 86. For example, the guard can pivot between open and closed. The guard can be considered to form a door.

Position lock 60 is configured to hold a displacer 28 in a position associated with the desired state. In the example shown, the position lock 60 interfaces with applicator frame 12 to lock the displacer 28 in a position associated with the stowed state or in a position associated with the immersed state. In some examples, the position lock 60 can be configured to lock the displacer 28 in one or more positions associated with intermediate states that are between the immersed state and the stowed state. For example, the position lock 60 can hold the displacer 28 in an intermediate state in which the pump 40 is withdrawn from the constituent material held within the material supply 42 but the pump 40 still extends through the top opening 54 and into the material supply 42. In the example shown, the position lock 60 is mounted to the mount bracket 58 to move with the mount bracket 58.

The position lock 60 is configured as a spring-biased lock in the example shown. The position lock 60 includes lock handle 126 that projects from mount bracket 58. The lock handle 126 can be grasped by a user and pulled to place position lock 60 in an unlocked state. Release of the lock handle 126 allows the spring to bias the position lock 60 into engagement with applicator frame 12 to place the position lock 60 back in the locked state. The position lock 60 can engage with the applicator frame 12 when in the locked state. The position lock 60 can include a post that projects through the mount bracket 58 to engage with the applicator frame 12 with the position lock 60 in the locked state. In some examples, the position lock 60 can be actuatable to remain in the unlocked state until manipulated to return to the locked state. For example, the user can pull lock handle 126 to the unlocked state and then rotate lock handle 126 to fix position lock 60 in the unlocked state. The user can then shift the displacer 28 to a desired position without having to manually maintain the position lock 60 in the unlocked state. The user can then reposition the lock handle 126, such as by rotating in an opposite direction, to allow the spring to bias the position lock 60 into engagement with applicator frame 12 and back to the locked state.

In the example shown, each displacer 28 is associated with a discrete position lock 60. As such, the dispense rig 10 shown includes a first position lock 60 associated with displacer 28a and a second position lock 60 associated with displacer 28b. The first position lock 60 can maintain drive assembly 38a of displacer 28a in the position associated with the stowed state even when pumps 40 are dismounted from drive assemblies 38. Similarly, the second position lock 60 can maintain drive assembly 38b of displacer 28b in the position associated with the stowed state even when pumps 40 are dismounted from drive assemblies 38. While dispense rig 10 is shown as including multiple position locks 60, it is understood that not all examples are so limited. For example, the drive assemblies 38a, 38b can be fixed together for simultaneous movement between immersed and stowed states even when pumps 40 are dismounted (e.g., by a bracket spanning between and connected to the drive assemblies 38a, 38b). In such an example, a single position lock 60 can maintain both drive assemblies 38 in a desired position.

Pumps 40 are mounted to drive assemblies 38 to form the displacers 28. As discussed above with regard to FIG. 2, pump 40 is mounted to drive assembly 38 at a dynamic interface and at a static interface. The static interface is secured by clamp 100 that fixes the pump housing 88 to the drive body 74 to fix the pump 40 relative to the drive assembly 38. The dynamic interface is formed between the piston 90 and the drive 72 and provides motive power to the pump 40. Drive assemblies 38 are mounted to applicator frame 12 and pumps 40 are connected to applicator frame 12 through drive assemblies 38.

Connecting bracket 62 extends between and is connected to pump 40a and pump 40b. Connecting bracket 62 fixes pumps 40a, 40b together. The pumps 40a, 40b are fixed together such that pumps 40a, 40b move together between the immersed and stowed states. Connecting bracket 62 projects longitudinally forward from each pump 40. In the example shown, the connecting bracket 62 projects longitudinally forward relative to the displacers 28 with the displacers 28 in the respective first and second immersed states. In the example shown, the connecting bracket 26 projects vertically above the displacers 28 with the displacers 28 in the respective first and second stowed states. The connecting bracket 62 extends laterally between the pumps 40 such that the connecting bracket 62 spans over the longitudinal centerline L-L. At least a portion of the connecting bracket 62 is disposed directly vertically above the top openings 54 of the material supplies 42 with the displacers 28 in the immersed states. Connecting bracket 62 being disposed above the material supplies 42 and projecting longitudinally from pumps 40 before spanning laterally between pumps 40 positions connecting bracket 62 for access by a user. The user is able to access connecting bracket 62 from either lateral side of dispense rig 10 and from the front end 44 of dispense rig 10. Such a configuration provides for efficient and easy actuation of the displacers 28 between the immersed and stowed states, as discussed in more detail below.

Connecting bracket 62 includes bracket body 128 and bracket handle 130. Bracket body 128 extends between and connects pumps 40a, 40b. Bracket handle 130 extends from the bracket body 128 of connecting bracket 62. Bracket handle 130 is disposed laterally between the locations that bracket body 128 interfaces with pumps 40. The bracket handle 130 projects vertically upwards from bracket body 128, with displacers 28 in the immersed states. Bracket body 128 extends longitudinally forwards in first longitudinal direction LT1 from pumps 40. The bracket body 128 projects longitudinally towards front end 44 of applicator frame 12. In some examples, bracket body 128 can project longitudinally forward such that at least a portion of bracket body 128 is disposed directly vertically above the front wheel 48b. In such an example, the bracket body 128 can be considered to vertically overlap with the front wheel.

Dispense support 24 is connected to connecting bracket 62. In the example shown, dispense support 24 is mounted to arm post 132 that extends from connecting bracket 62. The arm post 132 extends from a lower side of connecting bracket 62. The arm post 132 is disposed on an opposite side of bracket body 128 from bracket handle 130. Spacer arm 148 is movable vertically along arm post 132 to position dispenser 36 closer to or further from the ground surface, as discussed in more detail below. In the example shown, arm post 132 is disposed laterally between material supplies 42. In the example shown, arm post 132 is disposed laterally between pumps 40.

Dispense manifold 32 is supported by connecting bracket 62. In the example shown, dispense manifold 32 is mounted to connecting bracket 62. Specifically, dispense manifold 32 is mounted to a bottom side of bracket body 128. Dispense manifold 32 is disposed on an opposite side of connecting bracket 62 from bracket handle 130. Dispense manifold 32 being on a lower side of connecting bracket 62 shields the dispense manifold 32 from potential impact from above. Dispense manifold 32 is disposed at a longitudinal end of bracket body 128. In the example shown, dispense manifold 32 is disposed at a longitudinal front end of bracket body 128. Dispense manifold 32 is disposed at a longitudinally opposite end of connecting bracket 62 from the locations that connecting bracket 62 interfaces with pumps 40.

Supply line 30a extends from the pump outlet 110 of pump 40a to a first inlet of dispense manifold 32. Supply line 30a fluidly connects pump 40a to dispense manifold 32 and is configured to convey the first constituent material from pump 40a to dispense manifold 32. Supply line 30a is disposed on a lower vertical side of the connecting bracket 62. Supply line 30a is disposed vertically below bracket body 128. In some examples, supply line 30a is itself connected to connecting bracket 62, such as by a hose bracket that is mounted to connecting bracket 62. Supply line 30a interfaces with dispense manifold 32 at a location that is directly vertically below the bracket body 128 with the displacers 28 in the immersed states. The interface between supply line 30a and dispense manifold 32 is thus covered by bracket body 128 such that the joint between supply line 30a and dispense manifold 32 is covered and protected by the bracket body 128, preventing inadvertent impact while maneuvering dispense rig 10 or during mounting or dismounting of the fluid handling assembly 26.

Supply line 30b extends from the pump outlet 110 of pump 40b to a second inlet of dispense manifold 32. Supply line 30b fluidly connects pump 40b to dispense manifold 32 and is configured to convey the second constituent material from pump 40b to dispense manifold 32. Supply line 30b is disposed on a lower vertical side of the connecting bracket 62. Supply line 30b is disposed vertically below bracket body 128. In some examples, supply line 30b is itself connected to connecting bracket 62, such as by a hose bracket that is mounted to connecting bracket 62. Supply line 30b interfaces with dispense manifold 32 at a location that is directly vertically below the bracket body 128, with the displacers 28 in the immersed states. The interface between supply line 30b and dispense manifold 32 is thus covered by bracket body 128 such that the joint between supply line 30b and dispense manifold 32 is covered and protected by the bracket body 128, preventing inadvertent impact while maneuvering dispense rig 10 or during mounting or dismounting of the fluid handling assembly 26.

Mix line 34 is connected to dispense manifold 32. Mix line 34 is connected to an outlet of the dispense manifold 32. Mix line 34 is fluidly connected to a first fluid flowpath through the dispense manifold 32 that conveys the first constituent material and is fluidly connected to a second fluid flowpath through the dispense manifold 32 that conveys the second constituent material. The mix line 34 receives the outflow from the dispense manifold 32 and conveys the first and second constituent materials to dispenser 36. Dispenser 36 is mounted to an opposite end of mix line 34 from dispense manifold 32. Dispenser 36 is configured to output the plural component flooring material that is formed by the combination of the first and second constituent materials.

Fluid handling assembly 26 is formed by the various fluid-handling components of dispense rig 10. In the example shown, fluid handling assembly 26 includes pump 40a, pump 40b, supply line 30a, supply line 30b, dispense manifold 32, mix line 34, and dispenser 36. Fluid handling assembly 26 further includes connecting bracket 62 that connects the fluid-handling components together to form a single unit. Fluid handling assembly 26 further includes dispense support 24 that can support and position dispenser 36. The fluid handling assembly 26 can be mounted to dispense rig 10 and dismounted from dispense rig 10 as a single unit. The fluid handling assembly 26 is removable relative to the dry components of dispense rig 10 and the electrical components of dispense rig 10.

Displacers 28 are movable relative to applicator frame 12 to actuate displacers 28 between respective immersed and stowed states. In the example shown, displacers 28a, 28b are configured to pivot on pivots 116a, 116b, respectively, to move between the immersed and stowed states. While displacers 28 are shown as moving between the immersed and stowed states by pivoting, it is understood that not all examples are so limited. For example, displacers 28 can be configured to shift vertically to withdraw pumps 40 from material supplies 42 and move from the immersed to stowed states. In such a configuration, the drive assembly 38, including the electric motor 70, and the pump 40 can both be disposed directly vertically above the top opening 54 of the material supply 42 while in the stowed state.

Displacers 28 are placed in the respective immersed states to immerse pumps 40 in the constituent materials and position pumps 40 for drawing the constituent materials from the material supplies 42. In some examples, the pumps 40 can be considered to be in the immersed state when pump inlet 108 is disposed below the top opening 54 such that pump inlet 108 is within the material supply 42. The pump 40 can be considered to be immersed when the rigid structure defining the pump inlet 108 is disposed below the top opening 54 such that the rigid structure defining the pump inlet 108 is within the material supply 42. Additionally or alternatively, pump 40 can be considered to be in the immersed state when at least one valve (e.g., valve 92a and/or valve 92b) of the pump 40 is disposed below the top opening 54 such that the valve is disposed within the material supply 42. Additionally or alternatively, pump 40 can be considered to be in the immersed state when a dynamic seal of the pump 40 (e.g., dynamic seal 94a and/or dynamic seal 94b) is disposed below the top opening 54 such that the dynamic seal is disposed within the material supply 42.

Pumps 40 are configured as immersion pumps. Pumps 40 at least partially extending into the material supplies 42 reduces the length of the fluid pathways between material supply 42 and dispenser 36. Having pumps 40 disposed remote from material supplies 42 requires a hose to extend from the material supply 42 to the pump 40 to form a flowpath for the constituent material to be drawn into the pump 40. Such hoses can flex as constituent material flows through the hose to the pump. Pumps 40 being configured as immersion pumps inhibits cavitation, particularly when pumping viscous material. Providing a reduced length of the material flowpath from material supply 42 to dispenser 36 reduces the time and material required for cleaning of such flowpaths, providing time and cost savings. In addition, pump 40 directly drawing the material from the material supply 42 provides for a more efficient system that provides for simpler pressure and flow control by reducing lengths of flexible hosing.

Displacers 28 are pivotable between the immersed states and the stowed states in the example shown. Displacers 28 are shown in the immersed states in FIGS. 1A and 1B. Displacers 28 are shown in the stowed state in FIGS. 3A and 3B. In the example shown, each drive assembly 38 is individually mounted to applicator frame 12 to be individually supported by applicator frame 12. Fluid handling assembly 26 is supported by drive assemblies 38 to move with drive assemblies 38.

Position lock 60 can interface with applicator frame 12 to hold the displacers 28 in the respective stowed states. In the example shown, each position lock 60 can engage with applicator frame 12 to hold a displacer 28 in the stowed state. It is understood that, in some examples, dispense rig 10 may include only a single position lock 60 to secure displacers 28 in the stowed states. In such an example the connecting bracket or a separate bracket can extend between and interface with the two drive assemblies 38a, 38b to fix the drive assemblies 38 directly together. In the example shown, the drive assemblies 38 are fixed together by the pumps 40a, 40b and connecting bracket 62. The pair of position locks 60 individually fix the pair of drive assemblies 38a, 38b in the positions associated with the immersed and stowed states. The position locks 60 maintain drive assemblies 38 pivoted rearward even when fluid handling assembly 26 is dismounted from drive assemblies 38.

The displacers 28 can be pivoted by interfacing with fluid handling assembly 26. For example, the user can exert force on connecting bracket 62 (e.g., at bracket handle 130) and cause displacers 38 to pivot between the immersed and stowed states. The fluid handling assembly 26 is connected to the drive assemblies 38 such that exerting force on connecting bracket 62 exerts force on pumps 40, and pumps 40 transmit force to drive assemblies 38 to cause displacers 28 to pivot. In the example shown, displacers 28 pivot as a single unit between the immersed and stowed states. The fluid handling assembly 26 connects the drive assemblies 38a, 38b together such that displacers 28 pivots on pivots 116a, 116b. The fluid handling assembly 26 connecting drive assemblies 38 together facilitates simultaneous actuation of the displacers 28 between the respective immersed and stowed states.

In the example shown, pumps 40 are angled between vertical and horizontal when the pumps 40 are in the respective immersed states. As best seen in FIG. 3B, the pump axis PA is angled downwards towards the ground surface when in the stowed state. Pump 40 is disposed such that pump inlet 108 is vertically lower than the portion of pump housing 88 that interfaces with drive assembly 38. With displacers 28 in the stowed state, at least a portion of the pump 40 is disposed directly vertically above the top opening 54 of the material supply 42. With displacers 28 in the stowed state, at least a portion of the pump 40 is disposed directly vertically above a support 14. In the example shown, the portion of pump 40 disposed furthest in second axial direction AD2 along the pump axis PA forms a vertically lowest portion of the pump 40. The pump 40 being disposed over the material supply 42 allows constituent material residue that may be disposed on the exterior of the pump housing 88 to drip back into the material supply 42. In the example shown, displacers 28 pivots less than 90-degrees between the immersed and stowed states.

The pump axis PA is angled vertically downwards and has a slope between zero and one. The slope is the vertical distance change taken over the horizontal distance change between locations along the pump axis PA. The pump axis PA is disposed at an angle between vertical and horizontal. In the example shown, the pump axis PA is disposed such that angle a between horizontal and the pump axis PA is greater than 0-degrees and less than 45-degrees. In some examples, angle a is greater than about 5-degrees and less than about 30-degrees. Angle a is oriented to encourage component material residue to run towards the area defined by top opening 54 to drip back into material supply 42 rather than onto applicator frame 12, the ground surface, or some other location that can cause mess and require additional cleaning. The constituent material can run along the angled pump housing 88 to the portion of pump housing 88 directly vertically over the top opening 54. In the example shown, the pump housing 88 does not span fully across top opening 54 with displacers 28 in the stowed states. Instead, pump housing 88 spans only partially across the top opening 54 such that the terminal portion of pump housing 88 in second axial direction AD2 is disposed directly vertically over the top opening 54.

The pump 40 being disposed directly vertically above the top opening 54 when in the stowed state, the top opening 54 being the opening of the material supply 42 through which the pump 40 extends when in the immersed state, and the pump being angled downwards towards the ground surface facilitates clean servicing and removal of pumps 40. The angled configuration of pump 40 encourages any constituent material residue on the exterior of the pump housing 88 to flow along the pump housing 88 and towards the vertically lowest portion of the pump housing 88. The constituent material can then drip from the portion of the pump 40 that is disposed over the material supply and back into the material supply 42. While displacers 28 are shown as disposed between vertical and horizontal when in the stowed state, it is understood that not all examples are so limited. For example, displacers 28 can be disposed horizontally when in the stowed state in some examples.

In some examples, displacers 28 are configured such that all wetted exterior portions of pump 40 are disposed directly vertically over the top opening 54 of an associated material supply 42 with the displacer 28 in the stowed state. In such an example, displacer 28 is configured such that the portions of pump housing 88 actually immersed in the constituent material are disposed over the top opening 54. Such a configuration can facilitate no-drip removal of the material supply 42 with displacer 28 in the stowed state.

It is understood, however, that not all examples are so limited. For example, some wetted exterior portions of pump housing 88 may not be disposed directly vertically over the top opening 54. The angled configuration of displacer 28 facilitates the constituent material on such portions running along the pump housing 88 to portions of pump 40 directly vertically over the top opening 54.

The connecting bracket 62 spans over longitudinal centerline L-L and connects displacer 28a and displacer 28b together. With displacers 28 initially in the immersed state, force is applied to the connecting bracket 62, such as by the user grasping bracket handle 130, and drive assembly 38 is pivoted to place displacers 28 in the stowed states. The pumps 40a, 40b move about the pivots 116a, 116b, respectively, such that the pump axis PA of each pump 40 is reoriented to an orientation associated with the stowed state (e.g., between vertical and horizontal in the example shown).

Drive assemblies 38, including electric motors 70, move longitudinally rearward and vertically downwards relative to the positions of drive assembly 38 when in the immersed state. In the example shown, the pump inlet 108 moves longitudinally forwards and vertically upwards as displacer 28 moves between the immersed state and the stowed state. The pump inlet 108, which is the vertically lowest portion of pump 40 when displacer 28 is in the immersed state, moves longitudinally but remains in a wet area. The wet area is defined by the top opening 54 of the material supply 42 and is directly vertically over the support 14 of the material supply 42.

The pump housing 88 is the portion of pump 40 that has an exterior surface exposed to the constituent material. The constituent material can adhere to the exterior of the pump housing 88 as pump 40 is removed from the material supply 42. Positioning pump 40 such that lower portions of pump housing 88 are positioned directly vertically above the wet area defined by the top opening 54 of the material supply prevents drippage and facilitates no-drip removal of material supplies 42. In the example shown, at least 25% of a length of the pump housing 88 along pump axis PA is disposed directly vertically above the wet area. In some examples, at least 30% of the length of the pump housing 88 along pump axis PA is disposed directly vertically above the wet area. In some examples, at least 40% of the length of the pump housing 88 along pump axis PA is disposed directly vertically above the wet area. In some examples, at least 50% of the length of the pump housing 88 along pump axis PA is disposed directly vertically above the wet area. It is understood that, in some examples, up to 100% of the pump housing 88 is disposed directly vertically above the top opening 54, such as in examples in which displacers 28 elevate between the immersed and stowed states.

Each of the fluid handling components of dispense rig 10 shift positions between the immersed states and the stowed states, in the example shown. It is understood, however, that not all examples are so limited. In some examples, pumps 40 may move between the immersed and stowed states without the electric motors 70 also moving. In some examples, inlets of the pumps 40, such as suction tubes among other options, can pivot or otherwise move between immersed and stowed states.

In the example shown, the location where the constituent material enters into the fluid handling assembly 26 of dispense rig 10 (e.g., through pump inlet 108 in the example shown) moves into and out of the material supply 42 between the immersed and dispense states. Such movement allows for positioning of the inlet at a lower location within material supply 42 to draw a larger percentage of the volume from the material supply 42 as compared to positioning the intake vertically higher. Further, fully withdrawing the fluid inlet location from the material supply 42 facilitates dripping of residual material into the material supply 42 and removal and replacement of a material supply 42 without the user having to further interact with pumps 40.

With displacers 28 secured in the stowed states (e.g., by one or more position locks 60), the fluid handling assembly 26 can be dismounted from dispense rig 10. Each pump 40 is removable from the associated drive assembly 38. In the example shown, clamps 100 are unlocked to unsecure the static interfaces between pumps 40 and drive assemblies 38. Pumps 40 are then pulled radially relative to pump axis PA. Shifting the pumps 40 radially slides pump plate 112 of pump housing 88 along the drive plate 114 of drive body 74. The piston head 102 slides within and then out of slot 96 to break the dynamic connection between piston 90 and drive 72. In the example shown, the pumps 40a, 40b are fixed together by connecting bracket 62 such that pulling on connecting bracket 62 can simultaneously dismount pump 40a from drive assembly 38a and pump 40b from drive assembly 38b.

Fluid handling assembly 26 is shown in the dismounted state in FIGS. 4A and 4B. Dismounting fluid handling assembly 26 dismounts each of the fluid-handling components of dispense rig 10 as a single unit. The pumps 40, supply lines 30, dispense manifold 32, mix line 34, and dispenser 36 are all removable together as a single unit. The connecting bracket 62 fixes together and supports the various fluid-handling components. Fluid handling assembly 26 being removable as a single unit facilitates quick and efficient removal and replacement of the fluid-handling components. In some examples, the user may want to switch between dispensing a first plural component material made from a first combination of constituent materials to dispensing a second plural component material made from a different combination of constituent materials. The user can switch out fluid handling assemblies 26 to prevent possibility of cross-contamination. For example, the user can dismount a first fluid handling assembly 26 and mount a second, different fluid handling assembly 26 to drive assemblies 38. In some examples, a fluid handling assembly 26 can be dedicated to pumping a certain combination of constituent materials and the user can simply and easily swap out for a desired fluid handling assembly 26 associated with the particular combination of constituent materials in use.

The same or a different fluid handling assembly 26 can be mounted to the drive assemblies 38a, 38b. The drive assemblies 38 are dry components that do not directly handle the constituent material during operation. With fluid handling assembly 26 dismounted, the power and driving components of dispense rig 10 remain mounted on dispense rig 10.

Removal and replacement of fluid handling assembly 26 as a single unit reduces downtime and facilitates simple servicing of dispense rig 10. The user is not required to manipulate multiple or individual hose fittings during assembly and disassembly. Instead, the user can pull the fluid handling assembly 26 off of the drive assemblies 38 for dismounting or can mount the fluid handling assembly 26 to drive assemblies 38 for mounting. During mounting, the piston heads 102 are aligned with the slots 96 and fluid handling assembly 26 is shifted radially relative to the pump axis PA of a pump 40. The pump plate 112 is disposed below and interfaces with the drive plate 114 and the piston head 102 enters into the slot 96. The clamp 100 is engaged to lock pump housing 88 and drive body 74 together to form the static interface. With the clamps 100 secured, the displacers 28 can be moved to the immersed states to position the pumps 40 for pumping.

In the example shown, a pair of static interfaces and a pair of dynamic interfaces connect the fluid handling assembly 26 to the drive assemblies 38. Each pump 40 is connected by a single static interface and a single dynamic interface. The fluid-handling components are fluidly connected to each other. The outflows from pump 40a and pump 40b are directed to combine by the dispense manifold 32. The fluid handling components are structurally fixed together by connecting bracket 62. Connecting bracket 62 extends between and structurally connects pumps 40. Dispense manifold 32 is mounted to connecting bracket 62. Dispense support 24 extends from connecting bracket 62. Dispenser 36 is mounted to dispense support 24. The connecting bracket 62 connects the fluid-handling components together such that the fluid-handling components are movable as a single unit.

In the example shown, fluid handling assembly 26 includes the full fluid pathway between the material supplies 42 and the nozzle 64 of dispenser 36. The full fluid pathway extends from the pump inlet 108 of pump 40a to dispenser 36 and from pump inlet 108 of pump 40b to dispenser 36. The pump inlets 108 receive the constituent materials into the fluid pathway and the nozzle 64 of the dispenser 36 outputs the plural component material from the fluid pathway. The entirety of the fluid pathway of the first constituent material is mountable on and removable from dispense rig 10 as a single unit. The entirety of the fluid pathway of the second constituent material is mountable on and removable from dispense rig 10 as a single unit. Having the entirety of the various fluid pathways mountable to and dismountable from the driving components of dispense rig 10 facilitates quick and simple assembly and disassembly of dispense rig 10.

The couplings that connect fluid lines (e.g., mix line 34 and supply lines 30) to other components (e.g., pumps 40, dispense manifold 32, and dispenser 36) do not need to be manipulated for connection or disconnection during mounting or dismounting of fluid handling assembly 26. The fluid couplings remaining connected during mounting and dismounting of fluid handling assembly 26 eliminates mess and drippage that occur when disconnecting fluid fittings. Further, the fluid couplings do not require manipulation for connecting or disconnecting. Instead, only mechanical interfaces between the fluid handling assembly 26 and other components of dispense rig 10 are formed and broken during mounting and dismounting.

The pumps 40 shifting radially relative to the pump axis PA facilitates mounting and dismounting of pumps 40. Such a configuration allows for simultaneous mounting and dismounting of pumps 40 as the dynamic interface is formed by sliding of piston head 102 into slot 96 and static interface is aligned by relative radial movement between pump housing 88 and drive body 74. The pumps 40 do not require twisting about the pump axis PA of that pump during mounting, which would inhibit simultaneous mounting of the pumps 40a, 40b. Instead, the radial movement facilitates alignment for engagement of both the static and driving connections. The static interfaces mechanically support the fluid handling assembly 26. The driving, dynamic interface mechanically powers pumping by pumps 40.

Fluid handling assembly 26 being mountable to and dismountable from dispense rig 10 provides significant advantages. All fluid-handling components can be dismounted by a single action shifting fluid handling assembly 26 away from drive assemblies 38. The fluid handling assembly 26 is shifted longitudinally and/or vertically relative to applicator frame 12 during mounting and dismounting. The user can quickly and simply remove fluid handling assembly 26 and replace with another fluid handling assembly 26. The user can dismount all fluid lines of dispense rig 10 by a single motion that slides fluid handling assembly 26 relative to drive assemblies 38 to dismount pumps 40 from drive assemblies 38. The user can similarly mount all fluid lines of dispense rig 10 by a single motion that slides fluid handling assembly 26 relative to drive assemblies 38 to mount pumps 40 to drive assemblies 38. Such mounting and dismounting eliminates the need to make and break messy fluid connections between hoses as all hoses can remain fixed during mounting and dismounting.

FIG. 5A is an isometric view of dispense rig 10 with housing 22 removed to expose power supply 134. FIG. 5B is a top elevational view of dispense rig 10 with housing 22 removed. FIG. 5C is a side elevational view of dispense rig 10 with housing 22 removed.

FIG. 5D is a bottom elevational view of dispense rig 10 with housing 22 removed. FIG. 5E is a cross-sectional view of dispense rig 10 taken along line E-E in FIG. 5B. FIGS. 5A-5E are discussed together.

Dispense rig 10 is configured to move about a job site and generate and output a plural component flooring material. The plural component material is generated by dispense rig 10 on-board dispense rig 10 by combining discrete constituent materials together on-board dispense rig 10 to form the plural component material. The resultant plural component material is output onto the ground surface and cured in place to form the floor surface. Dispense rig 10 is configured to provide maneuverability about a job site while balancing components and providing access to various components for the user.

Applicator frame 12 supports other components of dispense rig 10. Wheels 48 are mounted to applicator frame 12 and are configured to roll along the ground surface to maneuver the dispense rig 10 about the job site and/or between job sites. Rear wheels 48a are mounted to a common axle 136 that extends longitudinally between the outer longitudinal sides of applicator frame 12. The rear axle 136 extends between and connects the rear wheels 48a. It is understood, however, that not all examples are so limited. For example, each rear wheel 48a can be directly mounted to the applicator frame 12 by its own bearing support. In such an example, the rear wheels 48a can rotate independently from each other.

Front wheel 48b is disposed at a front longitudinal end of applicator frame 12. Front wheel 48b is formed as a caster wheel that is configured to roll on a rotational axis (the rotational axis typically oriented parallel to the ground axis or horizontally) and pivot on a pivoting axis (e.g., a vertical pivoting axis). The front wheel 48b determines an orientation of dispense rig 10 as dispense rig 10 is maneuvered. The front wheel 48b is disposed to be aligned on a longitudinal centerline L-L of dispense rig 10 in the example shown.

Control 20 is disposed at a longitudinal rear end of applicator frame 12. Control 20 provides a location for a user to interact with dispense rig 10 to steer and maneuver dispense rig 10. Control 20 includes a user interface 18 through which the user can cause the dispense rig 10 to pump and output the constituent materials. The dispense rig 10 can be configured to move longitudinally forward and/or longitudinally rearward while outputting the plural component material. In the example shown, control 20 includes handlebars, through it is understood that not all examples are so limited.

Control module 16 is disposed at a rear longitudinal end of dispense rig 10. Control module 16 includes a module housing 56 within which various control components (e.g., computer memory, computer processing circuitry, printed circuit boards, etc.) can be stored. In some examples a bleed port is formed through the portion of the module housing 56 oriented towards power supply 134. The bleed port is configured such that the interior of the module housing 56 and the interior of the housing 22 are fluidly connected. Heat generated by the control elements within module housing 56 can flow through the bleed port and into the housing 22. Such heat can warm the power supply 134 (e.g., warm battery 138), improving the operating efficiency of battery 138.

Power supply 134 is supported by applicator frame 12. In the example shown, power supply 134 includes battery 138 and inverter 140. Power supply 134 is mounted on applicator frame 12 and is configured to be disposed within housing 22. Battery 138 can be configured as a removable and rechargeable battery, among other options. Battery 138 stores a supply of electric energy for powering operation of the electric motors 70 of displacers 28. Inverter 140 is configured to receive direct current (DC) power signals from battery 138 and output alternating current (AC) power signals. While dispense rig 10 is described as including a power supply 134 having an inverter 140, it is understood that not all examples are so limited. For example, dispense rig 10 can be configured with one or more batteries 138 but without an inverter 140. In such an example, the battery 138 can provide the DC power signals directly to the control components of control module 16 and/or electric motors 70 of displacers 28.

Power supply 134 spans over the longitudinal centerline L-L of the applicator frame 12. A Y-Z plane extending along the longitudinal centerline L-L will extend through the power supply 134. In the example shown, such a plane extends through each of the battery 138 and the inverter 140. The power supply 134 being disposed over the longitudinal centerline L-L provides weight balance to the dispense rig 10, providing for easy maneuvering by the user.

Power supply 134 is disposed in a longitudinal rearward portion 144 of dispense rig 10. In the example shown, the forward portion 142 of dispense rig 10 is disposed longitudinally forward of pivots 116a, 116b and the rearward portion 144 of dispense rig is disposed longitudinally rearward of pivots 116a, 116b.

Power supply 134 is disposed longitudinally rearward of pumps 40. Power supply 134 is longitudinally rearward of the pump inlet 108 of each pump 40 with the pump 40 in both the position associated with the immersed state and in the position associated with the 10 stowed state. Power supply 134 is disposed laterally between the pumps 40. Power supply 134 is disposed laterally between pumps 40 but is spaced longitudinally from pumps 40 such that power supply 134 is not directly laterally between pumps 40. Power supply 134 being disposed laterally between pumps 40 provides balance to dispense rig 10 during operation and when moving displacers 28 between the respective immersed and stowed states.

Power supply 134 being longitudinally rearward of the pumps 40 with the pumps 40 in both the immersed and stowed states protects the electrical components of dispense rig 10 from liquid contamination. The pumps 40 are not positioned to drip onto the housing 22 when in either the immersed or stowed states. The pumps 40 are instead disposed such that the wet portions of the pumps 40 remain mounted over the wet areas 156 of each support 14. The power supply 134 being rearward of pump inlets 108 protects power supply 134 while also balancing weight of the dispense rig 10.

Power supply 134 is disposed laterally between displacer 28a and displacer 28b. In the example shown, power supply 134 is disposed laterally between pumps 40a, 40b with displacers 28 in both the immersed state and the stowed state. In the example shown, power supply 134 is disposed laterally between drive assemblies 38a, 38b with displacers 28 in both the immersed state and the stowed state. In the example shown, power supply 134 is disposed laterally between material supplies 42 with displacers 28 in both the immersed state and the stowed state. In the example shown, power supply 134 is disposed vertically above the supports 14.

Power supply 134 is disposed longitudinally rearward of the displacers 28a, 28b. In the example shown, an overlap between power supply 134 and displacers 28 increases as the displacers 28 move from the immersed state to the stowed state. The drive assemblies 38 shift longitudinally rearward as the displacers 28 move to the stowed state. With displacers 28 in the stowed states the electric motors 70 are positioned such that at least a portion of the power supply 134 is directly laterally between the electric motor 70 of displacer 28a and the electric motor 70 of displacer 28b. In the example shown, battery 138 is disposed directly laterally between drive assemblies 38 with displacers 28 in the stowed states. In the example shown, the battery 138 is disposed directly laterally between the electric motors 70 with displacers 28 in the stowed states. As such, at least a portion of the power supply 134 laterally overlaps with the electric motors 70 with the displacers 28 in the respective stowed states. In the example shown, at least a portion of battery 138 is disposed directly laterally between the electric motors 70 when displacers 28 are in the stowed states. In the example shown, the power supply 134 is disposed vertically between a vertically highest part of the displacers 28 and a vertically lowest part of the displacers 28 with displacers 28 in the immersed states. In the example shown, power supply 134, specifically battery 138, is at least partially disposed vertically above a vertically highest vertical part of the displacers 28 with the displacers 28 in the stowed states.

Pivoting the displacers 28 to the stowed state facilitates ease of maneuvering for dispense rig 10 with the displacers 28 stowed. The drive assemblies 38, which include the heavy electronics and motor elements, are moved vertically downward, lowering the center of gravity of dispense rig 10. In addition, drive assemblies 38 are disposed on opposite lateral sides of longitudinal centerline L-L such that the center of gravity does not shift laterally as the displacers 28 are moved relative to the applicator frame 12.

Power supply 134 is disposed at a common longitudinal position as the rear wheels 48a. In the example shown, the power supply 134 is disposed directly vertically above rear axle 136 that spans between rear wheels 48a. Power supply 134 is disposed directly vertically above a line extending between the rotational axis of rear wheel 48a and the rotational axis of rear wheel 48b. In the example shown, such a line runs along rear axle 136, but it is understood that power supply 134 can be positioned directly vertically above such a location even if the rear wheels 48a are individually mounted directly to applicator frame 12 without a connecting rear axle 136. Positioning power supply 134 above the location between the rear wheels 48a provides balance to dispense rig 10 and allows for easier maneuvering. The user can tip dispense rig 10 on rear wheels 48, such as to move over a curb or other obstacle, and the power supply 134 being over rear axle 136 balances dispense rig 10.

Power supply 134 is disposed laterally between the rear wheels 48a. In the example shown, at least a portion of power supply 134 is disposed directly laterally between the rear wheels 48a. In the example shown, inverter 140 extends below the vertically highest point of each rear wheel 48a such that inverter 140 is disposed directly laterally between the rear wheels 48a. Battery 138 is disposed laterally between and vertically above rear wheels 48a. It is understood, however, that not all examples are so limited. For example, battery 138 can be disposed directly laterally between rear wheels 48a in some examples.

Battery 138 is mounted vertically above the inverter 140. In the example shown, battery 138 is disposed directly vertically above the inverter 140. Inverter 140 generates heat during operation. Battery 138 operates more efficiently in warm environments than in cooler environments. Battery 138 being disposed directly vertically above inverter 140 and within a common housing 22 positions battery 138 such that heat generated by inverter 140 rises to and around battery 138, increasing the temperature around battery 138 and providing a more efficient operating environment for battery 138. Battery 138 and inverter 140 are disposed within a common power supply chamber at least partially defined by housing 22. Disposing battery 138 and inverter 140 in a common housing 22 facilitates heat transfer to battery 138 from inverter 140.

Supports 14 are disposed on opposite lateral sides of the longitudinal centerline L-L. Support 14a forms a longitudinally forwardmost portion of applicator frame 12 on a first lateral side of longitudinal centerline L-L. Support 14b forms a longitudinally forwardmost portion of applicator frame 12 on a second lateral side of longitudinal centerline L-L. Supports 14a, 14b are disposed on opposite lateral sides of longitudinal centerline L-L. Power supply 134 is disposed laterally between an outer lateral side of support 14a and an outer lateral side of the support 14b. At least a portion of the front wheel 48b can be disposed directly laterally between the support 14a and support 14b. Front wheel 48b and power source 134 can be aligned on the longitudinal centerline L-L.

Support 14a extends laterally outward from a central portion of applicator frame 12. Support 14a is configured to support material supply 42a. Applicator frame 12 is configured such that material supply 42a is retained on support 14a longitudinally forward, longitudinally rearward, laterally to the left, and laterally to the right. To dismount material supply 42a, the material supply 42a first shifts vertically such that a lower end of the material supply 42 can clear either of longitudinal flange 50 or lateral flange 50 and then material supply 42 is shifted either laterally outward or longitudinally forward to dismount from support 14a.

Support 14a is disposed in a front right quarter area of the dispense rig 10. Support 14a can be considered to be disposed at a front corner of the dispense rig 10. Support 14a is disposed in forward portion 142 and laterally outward of longitudinal centerline L-L. Support 14a is positioned at a front corner facilitating ease of mounting and removal of material supply 42a. Support 14a positions material supply 42 such that material supply 42a extends further laterally outward away from longitudinal centerline L-L than rear wheels 48a. Lateral flange 50 is forms a laterally outermost portion of applicator frame 12. Having the material supply 42a disposed laterally outward positions material supply 42a for easy access by the user, such as for refilling, mounting, or removal.

Support 14b extends laterally outward from a central portion of applicator frame 12. Support 14b is configured to support material supply 42b. Applicator frame 12 is configured such that material supply 42b is retained on support 14b longitudinally forward, longitudinally rearward, laterally to the left, and laterally to the right. To dismount material supply 42b, the material supply 42b first shifts vertically such that a lower end of the material supply 42b can clear either of longitudinal flange 50 or lateral flange 50 and then material supply 42 is shifted either laterally outward or longitudinally forward to dismount from support 14b.

Support 14b is disposed in a front left quarter area of the dispense rig 10. Support 14b can be considered to be disposed at a front corner of the dispense rig 10. Support 14b is disposed in forward portion 142 and laterally outward of longitudinal centerline L-L. Support 14b is positioned at a front corner facilitating ease of mounting and removal of material supply 42b. Support 14b positions material supply 42b such that material supply 42b extends further laterally outward away from longitudinal centerline L-L than rear wheels 48a. Lateral flange 50 is forms a laterally outermost portion of applicator frame 12. Having the material supply 42b disposed laterally outward positions material supply 42b for easy access by the user, such as for refilling, mounting, or removal.

Material supplies 42a, 42b are supported on supports 14a, 14b, respectively. Material supplies 42a, 42b are disposed on opposite lateral sides of the longitudinal centerline L-L. Placing material supplies 42a, 42b on opposite lateral sides of centerline L-L facilitates balancing of dispense rig 10 and spaces material supplies 42a, 42b to prevent inadvertent cross-over of the constituent materials. Neither material supply 42a, 42b extends over or crosses the centerline L-L in the example shown.

The material supplies 42 are disposed longitudinally forward of the power supply 134. The positioning of the material supplies 42 relative to the power supply 134 provides balance to dispense rig 10 whether pushing or pulling dispense rig 10 during operation. The power supply 134 is disposed over the rear axle 136 and the material supplies 42 are disposed on an opposite longitudinal side of the rear axle 136 from the control 20. The user interfacing with control 20 on an opposite longitudinal side of power supply 134 from material supplies 42 provides balance between the user and material supplies 42, facilitating ease of maneuvering and operation.

In the example shown, the fluid pathway for the first constituent material remains on one lateral side of the centerline L-L and the fluid pathway for the second constituent material remains on a second opposite lateral side of the centerline L-L until the pathways combine at the output of dispense manifold 32. The dispense manifold 32 can span over the longitudinal centerline L-L. The mix line 34, which contains flows of the both the first and second constituent materials, can pivot to be on either lateral side of the centerline L-10 L, but the supply lines 30 that convey only one constituent material are fixed on opposite sides of the centerline L-L in the example shown.

The fluid flowpaths are disposed longitudinally forward of the power supply 134. The pumps 40, supply lines 30, dispense manifold 32, mix line 34, and dispenser 36 are all 15 disposed longitudinally forward of the power supply 134. In the example shown, constituent material enters into the fluid pathways (e.g., through pump inlets 108) at a location longitudinally forward of the power supply 134 and exits from the fluid pathways (e.g., through nozzle 64 of dispenser 36) at a location longitudinally forward of the power supply 134. The fluid passages do not overlap with or cross-over the power supply 134 either laterally or vertically. The power supply 134 is isolated from and positioned away from the fluid passages, preventing undesired liquid infiltration into the housing 22.

Power supply 134 is supported vertically above the ground surface. In the example shown, battery 138 is supported by a longitudinal beam of the applicator frame 12. The battery 138 is disposed such that at least a portion of the battery 138 is vertically above the material supplies 42. At least a portion of the battery 138 is vertically above the vertical height of the top opening 54 of the material supplies 42. The battery 138 being disposed vertically above the top opening 54 further positions battery 138 away from potential contamination, such as due to drippage or leaking.

Battery 138 is disposed vertically above pump inlets 108 of pumps 40 with displacers 28 in the respective immersed states. In the example shown, the battery 138 is disposed at least partially vertically above the pump inlets 108 with the displacers in the respective stowed states. Battery 138 is at least partially vertically above the locations where constituent material enters into the pumps 40 with pumps 40 both immersed within material supplies 42 and withdrawn from material supplies 42. Battery 138 is longitudinally rearward of the pump inlets 108 with displacers 28 in both the respective immersed and stowed states.

As discussed above, displacers 28 are movable relative to applicator frame 12 and relative to the material supplies 42. The displacers 28 are movable to place the displacers 28 in the respective immersed and stowed states. In the example shown, dispense rig 10 is configured such that material supplies 42 can be refilled with constituent material even while the displacers 28 remain in the respective immersed states. As best seen in FIG. 5B, displacers 28 are positioned to leave portions of the top opening 54 uncovered with displacer 28 in the immersed state.

Additional constituent material can be poured into the material supplies 42 through the uncovered area of the top opening 54. In the example shown, the uncovered area can be accessed laterally, from the outer lateral side, or longitudinally, such as from the forward longitudinal side. Additional constituent material can be poured through the uncovered area of the top opening 54 to refresh the supply of constituent material in material supply 42. In some examples, the uncovered area can be up to about 20% of the total area of the top opening 54. In some examples, the uncovered area can be up to about 30%, 40%, 50%, or more of the total area of the top opening 54. The uncovered area is configured to allow easy refreshing of the constituent material without having to shift displacers 28 or remove and replace the material supply 42 already disposed on support 14. Fluid handling assembly 26 is thus configured to support in-situ pouring of constituent material for filling of material supplies 42.

During operation, material supplies 42a, 42b are mounted to dispense rig 10 at supports 14a, 14b, respectively. The displacers 28a, 28b are pivoted from the respective stowed states to the respective immersed states. The pumps 40a, 40b enter into the material supplies 42 through the top openings 54 of the material supplies. The user can provide a command from control 20 to power electric motors 70 and cause pumping by pumps 40.

The battery 138 provides electrical power to operate electric motors 70. In the example shown, inverter 140 converts the DC power signal from battery 138 and outputs an AC power signal. The electric motors 70 provide motive power to reciprocate pistons 90 and pump the constituent materials. Pump 40a pumps the first constituent material through supply line 30a to dispense manifold 32. Pump 40b pumps the second constituent material through supply line 30b to dispense manifold 32. The first and second constituent materials are output to mix line 34 by dispense manifold 32. Dispenser 36 receives the flow from mix line 34 and outputs the plural component flooring material.

The user can refill either material supply 42a, 42b through the top opening 54 of that material supply 42 without having to place displacers 28 in the stowed states. Alternatively, the user can move the displacers 28 relative to the applicator frame 12 and to the respective stowed states. In such positions, the wetted portions of dispense rig 10 are still disposed longitudinally forward of power supply 134 and positioned away from power supply 134 to prevent any drips from reaching power supply 134. With the pumps 40 moved to the stowed states, the material supplies 42 can be removed for storage or replacement. As discussed above, the fluid handling assembly 26 can be removed as a single unit for storage or replacement.

Dispense rig 10 provides significant advantages. Power supply 134 is disposed on-board dispense rig 10 to power various electronic components of dispense rig 10. The power supply 134 is longitudinally rearward of fluid pathways of dispense rig 10. Such positioning inhibits liquid migration to the power supply 134, protecting power supply 134 from liquid contamination. The battery 138 is disposed at least partially vertically higher than the top openings 54 of material supplies 42, positioning battery 138 away from locations where liquid is likely to flow in case of leakage or dripping. Power supply 134 is disposed in rearward portion 144 while fluid pathways are in forward portion 142, further isolating power supply 134 from liquid.

In the example shown, the inverter 140 and battery 138 are disposed in a common housing 22 with the battery 138 disposed vertically above the inverter 140, encouraging heat rising to the battery 138 to warm the battery 138 and provide for more efficient operation of the battery 138. The module housing 56 can be open to the power supply cavity in housing 22 to further port heat to battery 138 to warm battery 138.

Power supply 134 is disposed laterally between the displacers 28, providing balance to dispense rig 10 and positioning power supply 134 away from fluid pathways. Battery 138 is disposed laterally between displacers 28. Power supply 134 is disposed directly vertically above the axle 136, providing balance to dispense rig 10 and facilitating maneuvering on job sites, such as for moving over curbs.

Supports 14 are disposed laterally outward from centerline L-L and power supply 134 spans over centerline L-L. Power supply 134 is at least partially laterally between the supports 14. Such a configuration positions power supply 134 laterally between material supplies 42 while also being longitudinally rearward of material supplies 42, inhibiting liquid migration to power supply 134.

FIG. 6A is an isometric view of dispense rig 10 showing dispense support 24 disposed to position dispenser 36 on a left lateral side of applicator frame 12. FIG. 6B is a front elevation view of dispense rig 10 showing dispense support 24 disposed to position dispenser 36 on a right lateral side of applicator frame 12. FIG. 6C is a front elevation view of dispense rig 10 showing dispense support 24 disposed to position dispenser 36 on the left lateral side of applicator frame. FIGS. 6A-6C are discussed together.

Dispense support 24 extends outward from applicator frame 12. Dispense support 24 is configured to support dispenser 36 relative to other components of dispense rig 10. In the example shown, dispense support 24 is connected to connecting bracket 62. Dispense support 24 is supported by connecting bracket 62 such that dispense support 24 moves with connecting bracket 62. Dispense support 24 forms a physical support element but does not itself define any fluid pathways of dispense rig 10. Dispense support 24 is configured to support dispenser 36 at a desired location relative to the ground surface and applicator frame 12 during maneuvering of dispense rig 10 and as the plural component material is dispensed. In the example shown, dispense support 24 is mounted to connecting bracket 62 such that dispense support 24 mounts with and dismounts with pumps 40.

Dispense support 24 includes dispense arm 146 and receiver 66. Dispense arm 146 is mounted to arm post 132 that projects from connecting bracket 62. Dispense arm 146 is movable along a length of arm post 132 to vertically reposition dispense support 24. Dispense arm 146 can be moved along arm post 132 to position receiver 66 closer to the ground surface or further from the ground surface. In the example shown, dispense arm 146 includes spacer arm 148 that is connected to arm post 132 and dispense arm 146 includes extension arm 150 that is mounted to spacer arm 148 and extends from spacer arm 148. In the example shown, extension arm 150 is repositionable relative to spacer arm 148 to manipulate the position of dispenser 36. While dispense arm 146 is shown as including multiple supporting arms, it is understood that not all examples are so limited. For example, dispense arm 146 can be formed as a single piece that extends outwards from arm post 132. As shown, spacer arm 148 is mounted to arm post 132 by arm clamp 152a and extension arm 150 is mounted to spacer arm 148 by arm clamp 152b. It is understood that a dispense arm 146 formed from a single piece can be mounted at a single arm clamp.

Dispense support 24 holds dispenser 36 at a desired location for dispensing. In the example shown, the dispenser 36 is posable to permit vertical and lateral positioning of a nozzle of the dispenser 36. The dispenser 36 is supported for lateral adjustment of the nozzle. The dispenser 36 is supported for vertical adjustment of the nozzle. The dispenser 36 is supported for pivoting about a vertical axis for adjustment of the nozzle. The dispenser 36 is supported to rotate for angular adjustment of the nozzle.

Receiver 66 is disposed at an end of dispense arm 146 opposite arm post 132. In the example shown, receiver 66 is mounted on extension arm 150. Receiver 66 is configured to interface with dispenser 36 and holds dispenser 36 at a desired location. In the example shown, dispenser 36 mounts to receiving bracket 68 of receiver 66.

Dispense support 24 is movable relative to applicator frame 12 to position dispenser 36 at a desired location relative to dispense rig 10. In the examples shown, dispense support 24 is movable to laterally reposition dispenser 36. Dispense support 24 can move about front end 44 of applicator frame 12 to reposition dispenser 36 between the left lateral side of dispense rig 10 and the right lateral side of dispense rig 10. For example, dispense support 24 can pivot on arm post 132 to be repositioned. In some examples, a clamp can be tightened to secure dispense support 24 in a desired orientation. In some examples, the dispense support 24 is movable at least 90-degrees about a front end 44 of the applicator frame 12. In some examples, the dispense support 24 is movable at least 180-degrees about the front end 44 of the applicator frame 12. In some examples, the dispense support 24 is movable at least 210-degrees about the front end 44 of the applicator frame 12.

In some examples, the dispense support 24 is movable to position the dispenser 36 laterally outward from a first rear wheel 48a on one lateral side of dispense rig 10 and laterally outward from a second rear wheel 48b on an opposite lateral side of dispense rig 10. The applicator arm can position the dispenser longitudinally forward of a front wheel 48b of the dispense rig 10.

The dispense support 24 is configured to laterally pivot to position the dispenser 36 on a first lateral side of the longitudinal centerline L-L of the dispense rig 10 and on the second lateral side of the longitudinal centerline L-L. In the example shown, spacer arm 148 is laterally movable relative to applicator frame 12 to laterally position dispenser 36. In the example shown, extension arm 150 is laterally movable relative to spacer arm 148 to further facilitate lateral repositioning of dispenser 36. For example, extension arm 150 can pivot on spacer arm 148 laterally to position dispenser 36. As such, the dispense support 24 shown includes a dual lateral pivot for positioning dispenser 36, though not all examples are so limited. In some examples, such as when dispense arm 146 is a single component, dispense support 24 can include a single lateral pivot for laterally positioning dispenser 36.

Additionally or alternatively to lateral positioning, dispense support 24 is movable relative to applicator frame 12 to position dispenser 36 vertically. In some examples, dispense arm 146 is vertically pivotable relative to applicator frame 12 to vertically reposition dispenser 36. For example. dispense arm 146 can pivot at the connection with arm post 132 to vertically shift displacer 28 closer to or further from the ground surface. Additionally or alternatively, dispense arm 146 can shift vertically relative to connecting bracket 62 to vertically reposition dispense support 24. For example, dispense arm 146 can shift vertically along the arm post 132 to reposition dispenser 36. In the example shown, spacer arm 148 is movable vertically along arm post 132 and can be fixed to arm post 132 at various vertical locations along arm post 132. Further, extension arm 150 is movable vertically along and relative to spacer arm 148 and can be fixed to spacer arm 148 at various vertical positions along spacer arm 148. The dispense support 24 can move along a vertical axis (e.g., along arm post 132) to shift vertically relative to the applicator frame 12.

In the example shown, dispense support 24 is shown in a vertically up position in FIG. 6B and in a vertically down position in FIG. 6C. Spacer arm 148 is connected to arm post 132 in a vertically upward position in FIG. 6B and extension arm 150 is connected to spacer arm 148 in a vertically upward position in FIG. 6B. Spacer arm 148 is shifted vertically downward along arm post 132 to a vertically downward position in FIG. 6C and extension arm 150 is shifted vertically downward along spacer arm 148 to a vertically downward position in FIG. 6C. The dispense support 24 shifting vertically facilitates vertical repositioning of dispenser 36 relative to the ground surface. For example, dispenser 36 can be positioned vertically closer to the ground surface during dispensing and can be elevated relative to the ground surface for maneuvering without dispensing, for storage, etc.

Dispense support 24 provides significant advantages. Dispense support 24 facilitates repositioning of dispenser 36 at desired locations relative to applicator frame 12.

The dispense support 24 can longitudinally pivot about front end 44 to position dispenser 36 laterally relative to applicator frame 12. Dispense support 24 can position the dispenser 36 laterally outward of other components of dispense rig 10 such that dispense rig 10 can be rolled along the ground surface while dispensing flooring material without concern of rolling over uncured flooring material. Dispense support 24 can vertically reposition dispenser 36 to allow dispenser 36 to be vertically closer or vertically further from the ground surface, as desired. In the example shown, the user can loosen one or more of arm clamps 152a, 152b to laterally and/or vertically position the displacer 28 and can tighten the one or more of arm clamps 152a, 152b to fix the position of dispenser 36. In some examples, arm clamps 152a, 152b are configured to movably fix dispenser 36 at a position relative to applicator frame 12. The dispenser 36 can be movably fixed such that arm clamps 152a, 152b hold dispenser 36 in a desired position but such that a user can reposition dispenser 36 by exerting force on dispense support 24 without having to manipulate an arm clamp 152a, 152b.

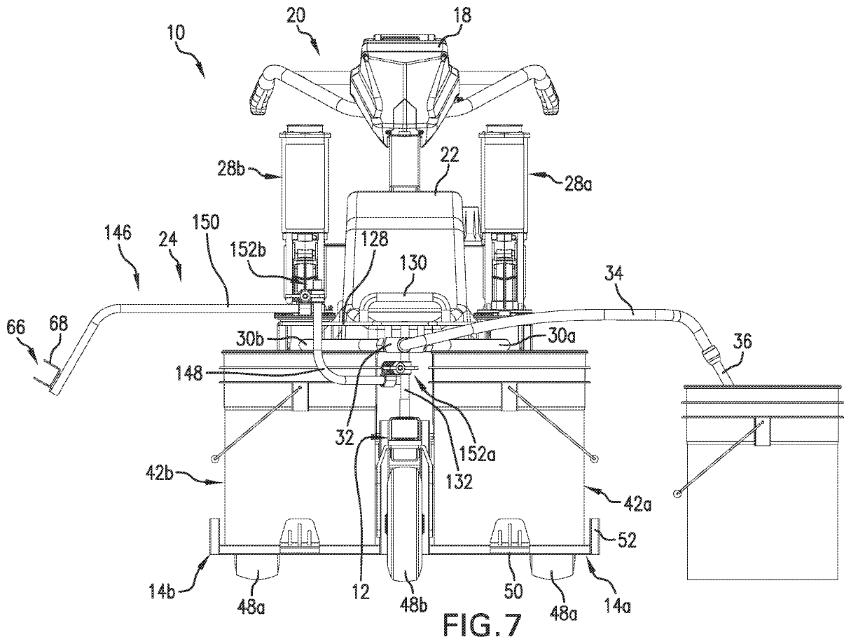

FIG. 7 is a front elevation view of dispense rig 10 showing dispenser 36 dismounted from dispense support 24. As discussed above, dispenser 36 is removably mountable to receiver 66. Dispenser 36 can be dismounted from receiver 66 and manually aimed and positioned for dispensing from dispenser 36. As shown, mix line 34 is unsupported between dispense manifold 32 and dispenser 36. Mix line 34 is not fixed to dispense support 24. Mix line 34 can be formed as a flexible hose such that mix line 34 can flex as dispenser 36 is positioned, which facilitates repositioning by dispense support 24 and manual positioning with dispenser 36 dismounted. Dispenser 36 can be dismounted by simply removing dispenser 36 from receiver 66 and without requiring manipulation of any connections holding the mix line 34 on the dispense support 24.

Dispenser 36 is mountable to and dismountable from receiver 66 without the use of tools. Dispenser 36 is held by but not fixed to receiver 66 in the example shown. In the example shown, dispenser 36 can be mounted to receiver 66 by shifting the dispenser 36 through the openings of receiving bracket 68 such that dispenser 36 extends through receiver 66. Dispenser 36 can be dismounted from receiver 66 by shifting dispenser 36 in an opposite direction and pulling dispenser 36 off of receiver 66. Dispenser 36 is withdrawn from the openings through receiving bracket 68 and is thus dismounted from dispense support 24. Dispenser 36 is mountable to and dismountable from the receiver 66 by shifting of the dispenser 36 along an axis of the dispenser 36 and relative to the receiver 66.

With dispenser 36 dismounted from dispense support 24, the user can grasp dispenser 36 and position dispenser 36 at a desired location. As shown in FIG. 7, the dispenser 36 can placed in or held over a bucket to dispense into the bucket, such as during purging of the fluid pathways with solvent or dispensing large volumes for use in other locations to which a bucket or other vessel can be carried. The dispenser 36 can be positioned at locations that may be difficult to reach with dispense rig 10, allowing mixing and dispensing of the plural component flooring material at such hard to reach locations.

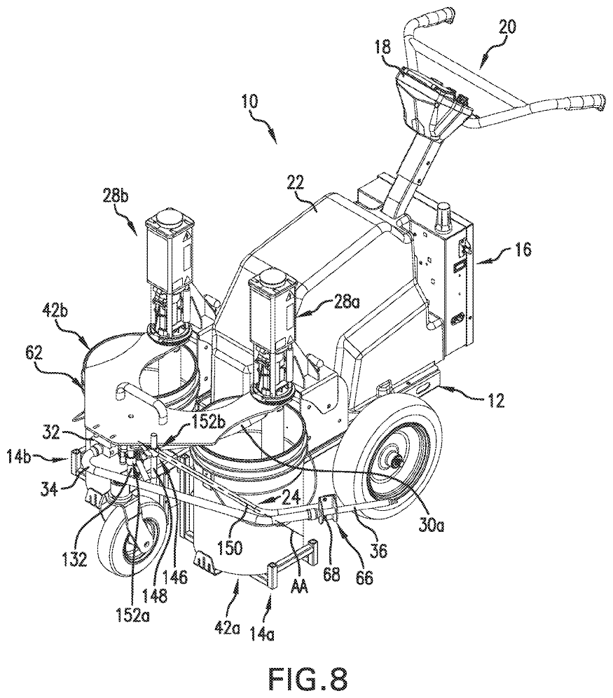

FIG. 8 is an isometric view of dispense rig 10 showing dispenser 36 in a displaced state. Dispenser 36 is mounted to dispense support 24 and supported by dispense support 24. Dispense support 24 is repositionable to adjust an orientation of the nozzle 64 of dispenser 36. Dispense support 24 extends away from applicator frame 12 along arm axis AA. In the example shown, the arm axis AA extends along extension arm 150 of dispense arm 146. The extension arm 150 is elongate along arm axis AA. Dispense support 24 is pivotable on arm axis AA to reorient dispenser 36. In the example shown, extension arm 150 is rotatable on arm axis AA such that nozzle 64 of dispenser 36 can be pivoted away from the ground surface to the displaced state shown in FIG. 8. In some examples, spacer arm 148 is similarly pivotable relative to arm post 132 in addition to or alternatively to extension arm 150 pivoting.

With dispenser 36 in the displaced state nozzle 64 is not oriented vertically downwards towards the ground surface. Instead, dispenser 36 extends longitudinally. Dispenser 36 can be placed in the displaced state to facilitate purging of fluid-handling components with solvent. For example, solvent can be pumped by pumps 40a, 40b, through supply lines 30a, 30b, through dispense manifold 32, through mix line 34, and through dispenser 36 to be output from dispense rig 10. The solvent is typically captured in a vessel, such as a bucket. The dispense support 24 can be positioned to orient dispenser in a dispense state (e.g., as shown in FIGS. 6A-6C) to output to the vessel and then pivoted to the displaced state to allow for removal of the bucket. A new bucket can be placed under dispenser 36 for additional purging as needed. Positioning dispenser 36 in the displaced state can inhibit dripping and other leakage from dispenser 36, allowing the user time to replace the vessel.

Dispense support 24 provides significant advantages. Dispense support 24 holds dispenser 36 away from other portions of dispense rig 10 allowing for emission of flooring material at locations where the dispense rig 10 will not roll over the freshly dispensed flooring material. Dispense support 24 is adjustable to reposition dispenser 36 to desired locations. Dispense support 24 can be laterally adjustable to reposition dispenser 36 about front end 44 of applicator frame 12. Dispense support 24 can position dispenser 36 laterally outward of applicator frame 12 on either lateral side of dispense rig 10. Dispense support 24 can position dispenser 36 laterally outward of wheels 48 on either lateral side of dispense rig 10. Dispense support 24 can be vertically adjustable to reposition dispenser 36 vertically closer to or vertically further from the ground surface. In some examples, dispense support 24 is pivotable to vertically adjust the position of dispenser 36. In some examples, dispense support 24 is elevatable to vertically adjust the position of dispenser 36. Dispense support 24 can be rotatably adjustable to reorient the nozzle 64 of dispenser 36. Rotatably adjusting dispense support 24 allows dispenser 36 to be oriented to facilitate placing a bucket under dispenser 36 or removing a bucket from under dispenser 36. Rotatably adjusting dispense support 24 can position dispenser 36 to inhibit dripping onto the ground surface, such as during transport or purging of fluid pathways.

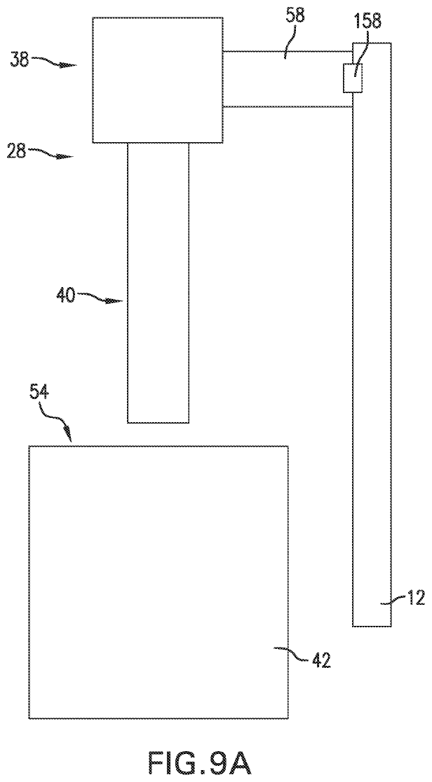

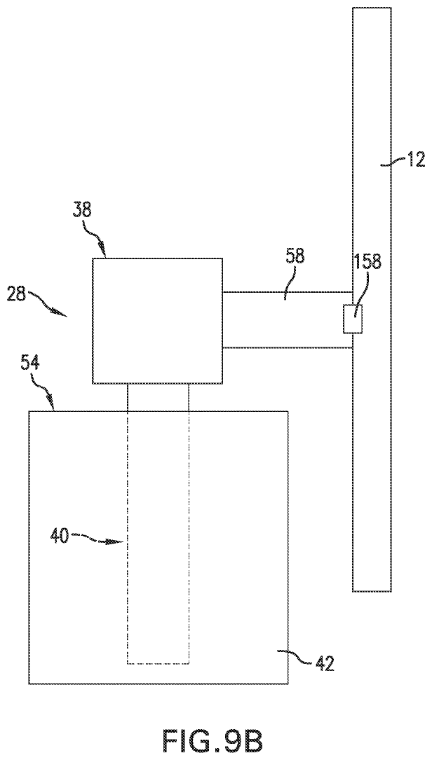

FIG. 9A is a block diagram showing a displacer 28 in an immersed state. FIG. 9B is a block diagram showing the displacer 28 in an elevated stowed state. Displacer 28 and material supply 42 are shown. A portion of applicator frame 12 is shown through other portions of dispense rig 10 are omitted for clarity. Pump 40 is mounted to drive assembly 38. Displacer 28 is shown in an elevated stowed state in which the displacer 28 is configured to shift vertically between the immersed and stowed states. Mount bracket 58′ extends between and connects drive assembly 38 to applicator frame 12. Elevator 158 is connected to drive assembly 38 and applicator frame 12. In the example shown, elevator 158 is directly connected to mount bracket 58′ and is connected to drive assembly 38 through mount bracket 58′.

Elevator 158 is configured to displace displacer 28 between immersed and stowed states. In the example shown, displacer 28 is configured to shift axially along pump axis PA between the immersed and stowed states. Both drive assembly 38 and pump 40 are disposed directly vertically above the top opening 54 of material supply 42 with displacer 28 in the stowed state.

Elevator 158 can be of any desired configuration suitable for vertically displacing displacer 28. For example, elevator 158 can be configured as a rack and pinion configuration, can be configured as a pully assembly, can be configured as one or more pistons that displace displacer 28 (e.g., pneumatic pistons among other options), etc. Elevator 158 is configured to displace displacer 28 between the immersed and stowed states.

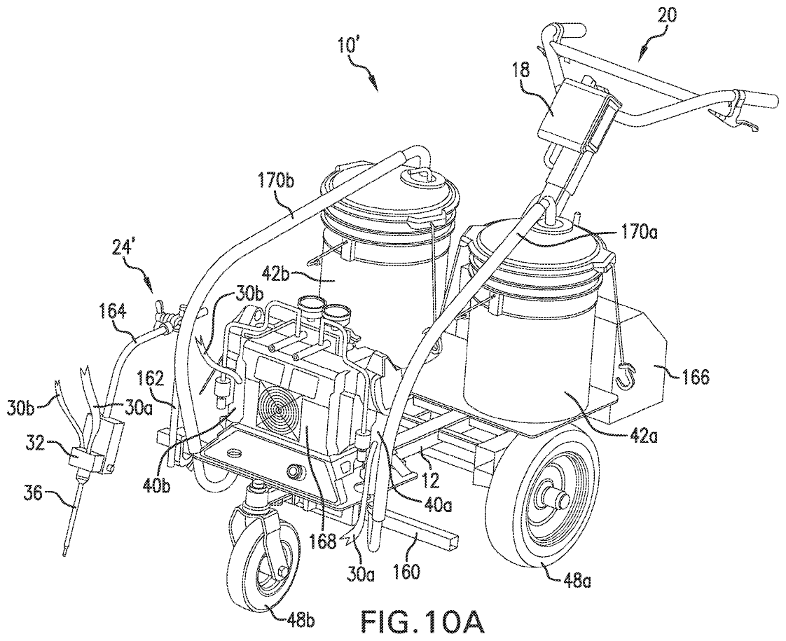

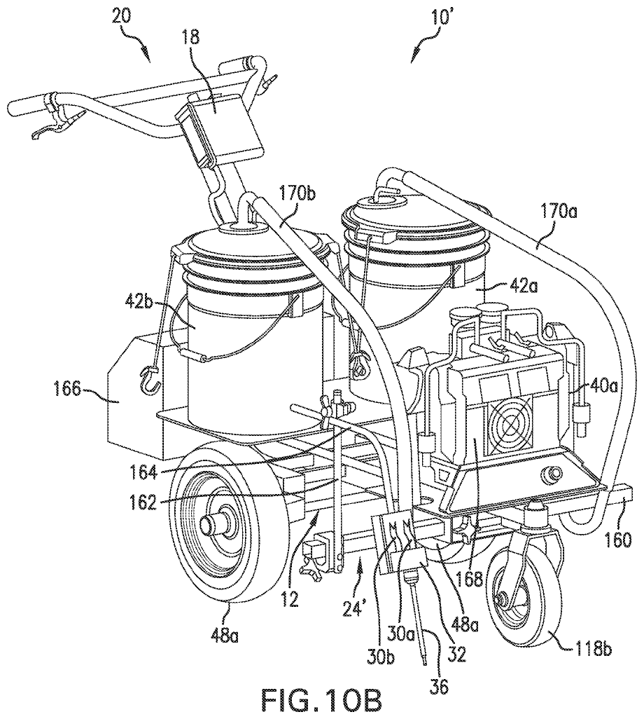

FIG. 10A is a first isometric view of a dispense rig 10′. FIG. 10B is a second isometric view of dispense rig 10′. FIGS. 10A and 10B are discussed together.

The floor dispense rig 10′ includes a dispenser 36. In the dispenser 36 can include a static mixer. The dispenser 36 includes a nozzle, such as on the end of the static mixer. A poseable holder 24′, similar to dispense support 24 (best seen in FIGS. 6A-6C and 8), poses the nozzle of the dispenser 36 in various positions and orientations. For example a lateral sliding arm 160 can extend the dispenser 36 laterally. A vertical arm 162 allows the height of the dispenser 36 to be adjusted. A pivoting arm 164 allows the dispenser 36 to be adjusted forward and backwards as well as side to side. The dispenser 36 can be mounted on either the left or the right side of the dispense rig 10′, although in the illustrated configuration the dispenser is located on the right side of the dispense rig 10′.

Dispense manifold 32 is disposed for receiving feeds of the first second constituent materials. The first and second constituent materials can be mixed in the manifold 32 or may be only mixed in the static mixer of the dispenser 36. In the example shown, manifold 32 and dispenser 36 can be considered to form a dispense assembly that is mounted to the holder 24′. In the example shown, dispenser 36 is mounted directly to manifold 32 to receive the constituent materials directly from the dispense manifold 32, though it is understood that not all examples are so limited. Feed lines 170a, 170b extend between material supplies 42a, 42b and pumps 40a, 40b, respectively. Supply lines 30a, 30b extend from pumps 40a, 40b to manifold 32.

The dispense rig 10′ includes a first material supply 42a and a second material supply 42b that respectively contain the first constituent material and the second constituent material. The material supplies 42a, 42b can be buckets, amongst other options.

The material supplies 42 are supported by applicator frame 12. The applicator frame 12 can be a structure of metal tubes, amongst other options. The applicator frame 12 rolls on a plurality of wheels. In this embodiment, a pair of rear wheels 48a support the frame 12 along with a front caster wheel 48b that rotates about a vertical axis for steering.

The dispense rig 10′ includes a proportioner 168. The proportioner 168 includes first pump 40a and a second pump 40b in an integrated unit driven by one motor (not shown). The first pump 40a and the second pump 40b are of equal displacement such that a 1:1 ratio will be dispensed. To dispense other ratios, the pumps can be modified for different displacements. For example, the second pump 40b can be replaced with another pump of different displacement volume to pump more of less of the second constituent material with each stroke.

In various other embodiments, each of the first pump 40a and the second pump 40b are driven by independent motors for which the respective speeds can be changed to change the output for mix ratios that are 1:1 or 1: X wherein X is not 1. As such, the ratio can be electrically controlled by respective motors driving respective pumps 40a and 40b. When using respective first pump 40a and second pump 40b, the pumps may be respectively mounted on the material supplies 42 such that a lower end of each pump is immersed in the respective first or second constituent material, similar to dispense rig 10. In this case, the motors can be respectively integrated with the pumps 40a and 40b, as discussed above with regard to displacers 28. In such an example, each of the pumps 40a, 40b can be moved (e.g., pivoted or elevated) to withdraw the lower end of the pump from the material supply 42 to allow swapping of the material supply. In some examples, each of the pumps can be independently pivoted to allow swapping of one material supply and not the other.

While the material supplies 42 are shown directly above the rear wheels 48a, in various other embodiments, the bottoms of the material supplies 42 are below the tops of the rear wheels 48a. In such embodiments, the material supplies 42 may be forward of the rear wheels 48a and rearward of the front wheel 48b, similar to dispense rig 10.

The dispense rig 10′ includes a control 20. The control 20 can include a steering structure, such as handlebars as shown, a steering wheel, or other structure. The dispense rig 10′ can be pushed or pulled by the user's hands gripping the control 20. The control 20 can include more inputs, which can be electronic inputs, such as buttons or switches, for controlling the proportioner 168 or otherwise controlling the motor(s) to control the pumps 40 to dispense.

The one or more motors that drive the pumps 40 can be electric motors. The electric motors can be powered by one or more batteries stored in the battery bay 166. The battery bay 166 can be supported by the applicator frame 12.

In use, the user can advance the floor dispense rig 10′ along the floor by pushing or pulling on the control 20 while actuating an input to cause the motor(s) to be powered by batteries of the battery bay 166 to operate the pumps 40 which causes the components to be drawn from the material supplies 42 by the first pump 40a and the second pump 40b to the dispenser 36 for mixing and dispensing onto the floor surface. The setup as a cart allows the dispense rig 10′ to dispense and move along the floor surface at the same time.

The dispenser 36 can comprise a first valve (not shown) that blocks the first fluid from flowing to mix with the second fluid until the first valve is overcome by upstream pressure from the first pump 40a, and a second valve (not shown) that blocks the second fluid from flowing to mix with the first fluid until the second valve is overcome by upstream pressure from the second pump 40b. This can prevent crossover mixing at locations upstream of dispenser 36.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A mobile floor surface dispense rig for applying a coating material to a flooring surface, the dispense rig comprising:
an applicator frame;
a plurality of wheels connected to the applicator frame and configured to support the applicator frame on the flooring surface;
at least one support connected to the applicator frame, the at least one support configured to support a first material supply holding a supply of a first material and a second material supply holding a supply of a second material;
a first displacer supported by the applicator frame and configured to draw the first material from the first material supply and pump the first material to a dispenser; and
a second displacer supported by the applicator frame and configured to draw the second material from the second material supply and pump the second material to the dispenser;
wherein the first displacer and the second displacer are movable relative to the applicator frame and between respective immersed states, in which the first displacer extends into the first material supply through a top opening of the first material supply and the second displacer extends into the second material supply through a top opening of the second material supply, and respective stowed states, in which the first displacer is removed from the first material supply and at least partially disposed over the top opening of the first material supply and the second displacer is removed from the second material supply and at least partially disposed over the top opening of the second material supply.

2. The mobile floor surface dispense rig of claim 1, wherein the first displacer comprises:
a first drive assembly including a first electric motor; and
a first pump connected to the first drive assembly to be powered to pump by the first drive assembly;
wherein the first pump extends into the first material supply through the top opening of the first material supply with the first displacer in a first immersed state of the respective immersed states.

3. The mobile floor surface dispense rig of claim 2, wherein a rigid fluid intake of the first pump is disposed within the first material supply with the first displacer in the first immersed state.

4. The mobile floor surface dispense rig of claim 2, wherein the second displacer comprises:
a second drive assembly including a second electric motor; and
a second pump connected to the second drive assembly to be powered to pump by the second drive assembly;
wherein the second pump extends into the second material supply through the top opening of the second material supply with the second displacer in a second immersed state of the respective immersed states.

5. The mobile floor surface dispense rig of claim 1, wherein a first fluid intake of a first pump of the first displacer is disposed directly vertically above the top opening of the first material supply with the first displacer in a first stowed state of the respective stowed states.

6. The mobile floor surface dispense rig of claim 5, wherein at least a portion of a first drive assembly connected to the first pump to power pumping by the first pump is not disposed directly vertically above the top opening of the first material supply with the first displacer in the first stowed state.

7. The mobile floor surface dispense rig of claim 6, wherein the first drive assembly is disposed directly vertically above the top opening of the first material supply with the first displacer in a first immersed state of the respective immersed states.

8. The mobile floor surface dispense rig of claim 5, wherein the first displacer is angled downwards towards the top opening of the first material supply with the first displacer in the first stowed state.

9. The mobile floor surface dispense rig of claim 5, wherein at least a portion of an electric motor of the first displacer is disposed vertically above a first pump of the first displacer with the first displacer in the first stowed state.

10. The mobile floor surface dispense rig of claim 1, wherein the first displacer is configured to pivot between the a first immersed state of the respective immersed states and a first stowed state of the respective stowed states.

11. The mobile floor surface dispense rig of claim 10, wherein:
the first displacer includes a first drive assembly having a first electric motor and includes a first pump having a first piston configured to be driven to reciprocate along a first pump axis by the first drive assembly, the first drive assembly is mounted to the applicator frame at a first pivot point.

12. The mobile floor surface dispense rig of claim 11, wherein the first pump is removable from the first drive assembly.

13. The mobile floor surface dispense rig of claim 12, wherein the first pump is configured to shift radially relative to the first pump axis to dismount from the first drive assembly.

14. (canceled)

15. The mobile floor surface dispense rig of claim 11, wherein:
the second displacer includes a second drive assembly having a second electric motor and includes a second pump having a second piston configured to be driven to reciprocate along a second pump axis by the second drive assembly; and
the second drive assembly is mounted to the applicator frame at a second pivot point.

16. (canceled)

17. The mobile floor surface dispense rig of claim 10, wherein the first displacer is connected to the second displacer such that the first displacer and the second displacer move together between the respective immersed states and the respective stowed states.

18. The mobile floor surface dispense rig of claim 1, wherein:
the first displacer includes a first drive assembly having a first electric motor and includes a first pump having a first piston configured to be driven to reciprocate along a first pump axis by the first drive assembly;
the second displacer includes a second drive assembly having a second electric motor and includes a second pump having a second piston configured to be driven to reciprocate along a second pump axis by the second drive assembly;
the first pump is removably mounted to the first drive assembly and the second pump is removably mounted to the second drive assembly; and
the first pump and the second pump are fixed together by a connecting bracket that spans over a longitudinal centerline of the dispense rig such that the first pump and the second pump are simultaneously mounted and dismounted.

19.-21. (canceled)

22. The mobile floor surface dispense rig of claim 1, wherein the first displacer and the second displacer are configured to elevate vertically between the respective immersed states and the respective stowed states.

23. (canceled)

24. (canceled)

25. The mobile floor surface dispense rig of claim 1, further comprising:
a position lock, the position lock configured to fix the first displacer in a first stowed state of the respective stowed states.

26.-67. (canceled)

68. A mobile floor surface dispense rig for applying a coating material to a flooring surface, the dispense rig comprising:
an applicator frame;
a plurality of wheels connected to the applicator frame and configured to support the applicator frame on the flooring surface;
at least one support connected to the applicator frame, the at least one support configured to support a first material supply holding a supply of a first material and a second material supply holding a supply of a second material;
a first displacer supported by the applicator frame, the first displacer including a first pump configured to draw the first material from the first material supply and pump the first material to a dispenser;
a second displacer supported by the applicator frame, the second displacer including a second pump configured to draw the second material from the second material supply and pump the second material to the dispenser;
a first supply line extending from the first pump to a dispense manifold, the first supply line configured to receive the first material output by the first displacer; and
a second supply line extending from the second pump to the dispense manifold, the second supply line configured to receive the second material output by the second displacer;
wherein the first pump, the second pump, the first supply line, the second supply line, and the dispense manifold are connected together as a fluid handling assembly configured to move together as a single unit between a first state in which the first pump and the second pump are in respective immersed states in which the first pump extends into the first material supply through a top opening of the first material supply and the second pump extends into the second material supply through a top opening of the second material supply, and a second state in which the first pump and the second pump are in respective stowed states in which the first pump is removed from the first material supply and at least partially disposed over the top opening of the first material supply and the second pump is removed from the second material supply and at least partially disposed over the top opening of the second material supply.

69.-80. (canceled)

81. A mobile floor surface dispense rig for applying a coating material to a flooring surface, the dispense rig comprising:
an applicator frame;
a plurality of wheels connected to the applicator frame and configured to support the applicator frame on the flooring surface;
at least one support connected to the applicator frame, the at least one support configured to support a first material supply holding a supply of a first material and a second material supply holding a supply of a second material;
a first displacer supported by the applicator frame, the first displacer comprising:
a first drive assembly; and
a first pump connected to the first drive assembly to be driven by the first drive assembly to draw the first material from the first material supply and pump the first material to a dispenser;
wherein the first pump is removably mounted to the first drive assembly; and
a second displacer supported by the applicator frame, the second displacer comprising:
a second drive assembly; and
a second pump connected to the second drive assembly to be driven by the second drive assembly to draw the second material from the second material supply and pump the second material to a dispenser;
wherein the second pump is removably mounted to the second drive assembly;
wherein the first pump is fixed to the second pump such that the first pump and the
second pump are removable together from the first drive assembly and the second drive assembly and are mountable together from the first drive assembly and the second drive assembly.

82.-226. (canceled)
